(19) United States
(12) Patent Application Publication
(10) Pub. No.: US 2024/0264411 A1
(43) Pub. Date: Aug. 8, 2024

(54) OPTICAL SYSTEM AND CAMERA MODULE COMPRISING SAME

(71) Applicant: LG INNOTEK CO., LTD., Seoul (KR)

(72) Inventor: Doo Shik SIN, Seoul (KR)

(21) Appl. No.: 18/570,453

(22) PCT Filed: Jun. 17, 2022
(86) PCT No.: PCT/KR2022/008639

§ 371 Date: Dec. 14, 2023

(30) Foreign Application Priority Data
Jun. 18, 2021 (KR) 10-2021-0079394

(51) Int. Cl. G02B 13/00; G02B 9/64

(52) U.S. Cl. CPC G02B 13/0045; G02B 9/64

(57) ABSTRACT

An optical system disclosed to an embodiment of the invention includes first to ninth lenses disposed along an optical axis in a direction from the object side to the sensor side, wherein the first, fifth, and ninth lenses have negative refractive power on the optical axis, and the fourth and eighth lenses have positive (+) refractive power on the optical axis, and an object-side surface of the first lens includes a first critical point, wherein the first critical point is disposed in a range of 20% to 50% of an effective radius of the object-side surface of the first lens with respect to the optical axis.

### TECHNICAL FIELD

An embodiment relates to an optical system for improved optical performance and a camera module including the same.

### BACKGROUND ART

The camera module captures an object and stores it as an image or video, and is installed in various applications. In particular, the camera module is produced in a very small size and is applied to not only portable devices such as smartphones, tablet PCs, and laptops, but also drones and vehicles to provide various functions. For example, the optical system of the camera module may include an imaging lens for forming an image, and an image sensor for converting the formed image into an electrical signal. In this case, the camera module may perform an autofocus (AF) function of aligning the focal lengths of the lenses by automatically adjusting the distance between the image sensor and the imaging lens, and may perform a zooning function of zooming up or zooning out by increasing or decreasing the magnification of a remote object through a zoom lens. In addition, the camera module employs an image stabilization (IS) technology to correct or prevent image stabilization due to an unstable fixing device or a camera movement caused by a user's movement.

The most important element for this camera module to obtain an image is an imaging lens that forms an image. Recently, interest in high efficiency such as high image quality and high resolution is increasing, and research on an optical system including plurality of lenses is being conducted in order to realize this. For example, research using a plurality of imaging lenses having positive (+) and/or negative (−) refractive power to implement a high-efficiency optical system is being conducted. However, when a plurality of lenses is included, there is a problem in that it is difficult to derive excellent optical properties and aberration properties. In addition, when a plurality of lenses is included, the overall length, height, etc. may increase due to the thickness, interval, size, etc. of the plurality of lenses, thereby increasing the overall size of the module including the plurality of lenses. In addition, the size of the image sensor is increasing to realize high-resolution and high-definition. However, when the size of the image sensor increases, the TTL (Total Track Length) of the optical system including the plurality of lenses also increases, thereby increasing the thickness of the camera and the mobile terminal including the optical system. Therefore, a new optical system capable of solving the above problems is required.

### DISCLOSURE

### Technical Problem

An embodiment of the invention is to provide an optical system with improved optical properties. The embodiment is intended to provide an optical system having excellent performance in the center portion and the periphery portion. The embodiment is intended to provide an optical system capable of having a slim structure.

### Technical Solution

An optical system according to an embodiment of the invention comprises first to ninth lenses disposed along an optical axis in a direction from an object side to a sensor side, wherein the first lens has negative (−) refractive power on the optical axis, and the fourth lens has positive (+) refractive power on the optical axis, the fifth lens has negative (−) refractive power on the optical axis, and the eighth lens has positive (+) refractive power on the optical axis, and the ninth lens has a negative refractive power on the optical axis and an object-side surface of the first lens includes a first critical point, wherein the first critical point may be disposed in a range of 20% to 50% of an effective radius of an object-side surface of the first lens with respect to the optical axis.

According to an embodiment of the invention, the object-side surface of the first lens on the optical axis may be concave, and the sensor-side surface of the first lens on the optical axis may be concave. The object-side surface of the first lens among object-side surfaces and sensor-side surfaces of the first to ninth lens may have the largest effective diameter (clear aperture (CA)).

According to an embodiment of the invention, a refractive index of the first lens with respect to the d-line wavelength is nd1, and the following equation may satisfy: 1.4<nd1<1.6.

According to an embodiment of the invention, Abbe number of the fifth lens may be Vd5, and the following equation may satisfy: 10<Vd5<30.

According to an embodiment of the invention, an object-side surface of the ninth lens includes a second critical point, and the second critical point may be disposed in a range of 20% to 50% of an effective radius of the object-side surface of the ninth lens with respect to the optical axis.

According to an embodiment of the invention, a sensor-side surface of the ninth lens includes a third critical point, wherein the third critical point may be disposed in a range of 40% to 70% of an effective radius of the object-side surface of the ninth lens with respect to the optical axis.

An optical system according to an embodiment of the invention comprises first to ninth lenses disposed along an optical axis in a direction from an object side to a sensor side, wherein the first lens has a negative (−) refractive power on the optical axis, the fourth lens has positive (+) refractive power on the optical axis, the fifth lens has negative (−) refractive power on the optical axis, the eighth lens has positive (+) refractive power on the optical axis, and the ninth lens has a negative (−) refractive power on the optical axis and has a field of view (FOV) exceeding 110 degrees.

According to an embodiment of the invention, the object-side surface of the first lens among object-side surfaces and sensor-side surfaces of the first to ninth lens may have the largest effective diameter. According to an embodiment of the invention, CA_L1S1 is an effective diameter of the object-side surface of the first lens, CA_L1S2 is an effective diameter of the sensor-side surface of the first lens, and the following equation may satisfy: 1.5<CA_L1S1/CA_L1S2<3. According to an embodiment of the invention, CA_L1S1 is an effective diameter of the object-side surface of the first lens, CA_L1S2 is an effective diameter of the sensor-side surface of the first lens, and the following equation may satisfy: 0.4<L1_CT/L1_ET<1.

An optical system according to an embodiment of the invention comprises first to ninth lenses disposed along an optical axis in a direction from an object side to a sensor side, the first lens has a negative (−) refractive power on the optical axis, the fourth lens has positive (+) refractive power on the optical axis, the fifth lens has negative (−) refractive power on the optical axis, and the eighth lens has positive (+) refractive power on the optical axis, and the ninth lens has a negative (−) refractive power on the optical axis, and a distance in a direction of the optical axis between the first and second lenses decreases from the optical axis in a direction perpendicular to the optical axis.

According to an embodiment of the invention, d12_CT is a distance in a direction of the optical axis between the first and second lenses on the optical axis, and d12_ET is a distance in a direction of the optical axis between the first and second lenses at an end of the effective region of the object-side surface of the second lens, and the following equation may satisfy: 2<d12_CT/d12_ET<3.

According to an embodiment of the invention, a distance in a direction of the optical axis between the eighth and ninth lenses may increase from the optical axis toward a first point on the sensor side of the eighth lens, and may decrease from the first point toward an end of the sensor-side surface of the eighth lens.

According to an embodiment of the invention, the first point may be disposed in a range of 60% to 80% of an effective radius of the sensor-side surface of the eighth lens with respect to the optical axis.

A camera module according to an embodiment of the invention may include the optical system disclosed above.

### Advantageous Effects

The optical system and the camera module according to the embodiment may have improved optical properties. In detail, the optical system according to the embodiment may have improved resolution as the plurality of lenses have a set shape, focal length, and the like. The optical system according to the embodiment has a wide angle of view and can effectively control light incident with a large viewing angle. Accordingly, the optical system may have good optical performance at the center portion and the periphery portion of the angle of view. The optical system according to the embodiment may have improved optical characteristics and a small total track length (TTL), so that the optical system and a camera module including the same may be provided in a slim and compact structure.

### DESCRIPTION OF DRAWINGS

FIG. 1 is a block diagram of an optical system according to a first embodiment of the invention.

FIG. 2 is a graph showing aberration characteristics of the optical system according to the first embodiment.

FIG. 3 is a block diagram of an optical system according to a second embodiment.

FIG. 4 is a graph showing aberration characteristics of the optical system according to the second embodiment.

FIG. 5 is a block diagram of an optical system according to a third embodiment.

FIG. 6 is a graph showing aberration characteristics of the optical system according to the third embodiment.

FIG. 7 is a diagram illustrating that the camera module according to the embodiment is applied to a mobile terminal.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology. Further, the terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C.

In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element.

“Object-side surface” may refer to a surface of the lens facing the object-side surface with respect to the optical axis, and “sensor-side surface” may refer to a surface of the lens facing the imaging surface (image sensor) with respect to the optical axis. A convex surface of the lens may mean that the lens surface on the optical axis has a convex shape, and a concave surface of the lens may mean that the lens surface on the optical axis has a concave shape. The radius of curvature, center thickness, and distance between lenses described in the table for lens data may mean values on the optical axis, and the unit is mm. The vertical direction may mean a direction perpendicular to the optical axis, and an end of the lens or the lens surface may mean the end or edge of the effective region of the lens through which the incident light passes.

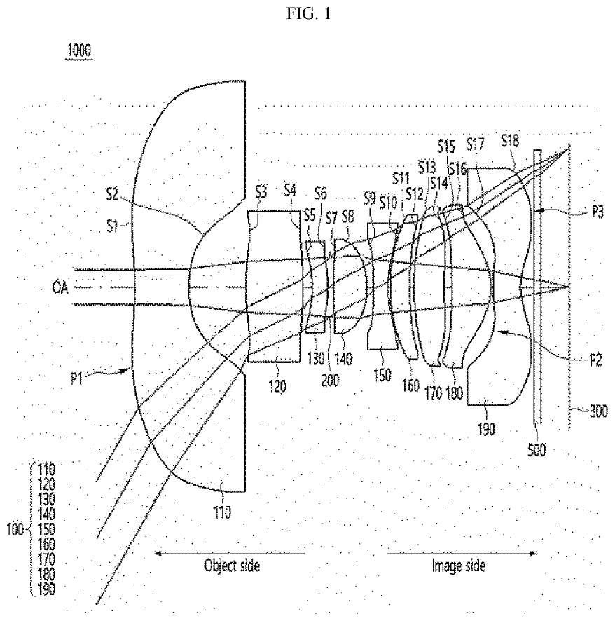

FIGS. 1, 3, and 5 are views illustrating an optical system and a camera module having the same according to embodiments.

1, 3, and 5, the optical system 1000 according to the embodiment may include a plurality of lenses 100 and an image sensor 300. For example, the optical system 1000 may include five or more lenses. In detail, the optical system 1000 may include eight or more lenses. The optical system 1000 may include nine lenses. The optical system 1000 may include a first lens 110 to a ninth lens 190 and an image sensor 300 sequentially arranged from the object side to the sensor side.

The first to ninth lenses 110, 120, 130, 140, 150, 160, 170, 180 and 190 may be sequentially disposed along the optical axis OA of the optical system 1000. The light corresponding to the object information may pass through the first lens 110 to the ninth lens 190 and be incident on the image sensor 300. Each of the plurality of lenses 100 may include an effective region and an ineffective region. The effective region may be a region through which light incident on each of the first to ninth lenses 110, 120, 130, 140, 150, 160, 170, 180 and 190 passes. That is, the effective region may be a region in which incident light is refracted to implement optical properties, and may represent an effective diameter. The ineffective region may be disposed around the effective region. The ineffective region may be an area to which light is not incident from the plurality of lenses 100. That is, the ineffective region may be a region independent of the optical characteristic. Also, the ineffective region may be a region fixed to a barrel (not shown) for accommodating the lens.

The image sensor 300 may detect light. In detail, the image sensor 300 may detect the light sequentially passing through the plurality of lenses 100, in detail, the plurality of lenses 100. The image sensor 300 may include a device capable of detecting incident light, such as a charge coupled device (CCD) or a complementary metal oxide semiconductor (CMOS).

The optical system 1000 according to the embodiment may further include a filter 500. The filter 500 may be disposed between the plurality of lenses 100 and the image sensor 300. The filter 500 may be disposed between the image sensor 300 and the last lens disposed closest to the image sensor 300 among the plurality of lenses 100. For example, when the optical system 1000 includes nine lenses, the filter 500 may be disposed between the ninth lens 190 and the image sensor 300. The filter 500 may include at least one of an infrared filter and an optical filter such as a cover glass. The filter 500 may pass light of a set wavelength band and filter light of a different wavelength band. When the filter 500 includes an infrared filter, radiant heat emitted from external light may be blocked from being transmitted to the image sensor 300. In addition, the filter 500 may transmit visible light and reflect infrared light.

Also, the optical system 1000 according to the embodiment may include an aperture stop (not shown). The aperture stop may control the amount of light incident on the optical system 1000. The aperture stop may be disposed at a set position. For example, the aperture stop may be located in front side of the first lens 110 or may be located at a rear side of the first lens 110. Also, the aperture stop may be disposed between two lenses selected from among the plurality of lenses 100. For example, the aperture stop may be positioned between the third lens 130 and the fourth lens 140. Alternatively, at least one lens selected from among the plurality of lenses 100 may serve as an aperture stop. In detail, the object side or sensor side of one selected from the first to ninth lenses 110, 120, 130, 140, 150, 160, 170, 180, and 190 may serve as an aperture stop for controlling the amount of light. For example, the sensor-side surface (sixth surface S6) of the third lens 130 or the object-side surface (seventh surface S7) of the fourth lens 140 may serve as an aperture stop.

The optical system 1000 may include at least one light path changing member (not shown). The light path changing member may change the path of the light by reflecting the light incident from the outside. The light path changing member may include a reflector and a prism. For example, the light path changing member may include a right-angled prism. When the light path changing member includes a right-angle prism, the light path changing member may change the path of the light by reflecting the path of the incident light at an angle of 90 degrees. The light path changing member may be disposed closer to the object side than the plurality of lenses 100. That is, when the optical system 1000 includes one light path changing member, the optical path changing member, the first lens 110, the second lens 120, and the third lens 130, the fourth lens 140, the fifth lens 150, the sixth lens 160, the seventh lens 170, the eighth lens 180, the ninth lens 190, the filter 500 and the image sensors 300 may be arranged in order from the object side to the sensor direction. Alternatively, the light path changing member may be disposed between the plurality of lenses 100. For example, the light path changing member may be disposed between an nth lens and an n+1th lens. Alternatively, the light path changing member may be disposed between the plurality of lenses 100 and the image sensor 300. The light path changing member may change a path of light incident from the outside in a set direction. For example, when the optical path changing member is disposed closer to the object side than the plurality of lenses 100, the optical path changing member may change a path of the light incident on the optical path changing member in the first direction to the plurality of lenses to a second direction (a direction of the optical axis OA of the drawing in a direction in which a plurality of lenses 100 are spaced apart) that is an arrangement direction of the plurality of lenses 100. When the optical system 1000 includes a light path changing member, the optical system may be applied to a folded camera capable of reducing the thickness of the camera.

In detail, when the optical system 1000 includes the light path changing member, light incident in a direction perpendicular to the surface of the device to which the optical system 1000 is applied may be changed in a direction parallel to the surface of the device. Accordingly, the optical system 1000 including the plurality of lenses 100 may have a thinner thickness in the device, and thus the device may be provided thinner. For example, when the optical system 1000 does not include the light path changing member, the plurality of lenses 100 may be disposed to extend in a direction perpendicular to the surface of the device in the device. Accordingly, the optical system 1000 including the plurality of lenses 100 has a high height in a direction perpendicular to the surface of the device, and therefore, it may be difficult to form a thin thickness of the optical system 1000 and a device including the same. However, when the optical system 1000 includes the light path changing member, the plurality of lenses 100 may be disposed to extend in a direction parallel to the surface of the device. That is, the optical system 1000 is disposed so that the optical axis OA is parallel to the surface of the device, and may be applied to a folded camera. Accordingly, the optical system 1000 including the plurality of lenses 100 may have a low height in a direction perpendicular to the surface of the device. Accordingly, the camera including the optical system 1000 may have a thin thickness in the device, and the thickness of the device may also be reduced.

Hereinafter, the plurality of lenses 100 according to the embodiment will be described in more detail.

The first lens 110 may have negative (−) refractive power on the optical axis OA. The first lens 110 may include a plastic or glass material. For example, the first lens 110 may be made of a plastic material. The first lens 110 may include a first surface S1 defined as an object-side surface and a second surface S2 defined as a sensor-side surface. The first surface S1 may have a concave shape on the optical axis OA, and the second surface S2 may be concave on the optical axis OA. That is, the first lens 110 may have a concave shape on both sides of the optical axis OA. At least one of the first surface S1 and the second surface S2 may be an aspherical surface. For example, both the first surface S1 and the second surface S2 may be aspherical.

The first lens 110 may include at least one critical point. In detail, at least one of the first surface S1 and the second surface S2 may include a critical point. Here, the critical point may mean a point at which the slope of the tangent to the lens surface is 0. In detail, the critical point is a point at which the sign of the inclination value with respect to the optical axis OA and the direction perpendicular to the optical axis OA changes from positive (+) to negative (−) or from negative (−) to positive (+), and may mean a point at which the slope value is 0. For example, the first surface S1 may include a first critical point P1 defined as a critical point. The optical axis OA is the starting point and the end point of the first surface S1 of the first lens 110 is the end point, the first critical point P1 may be disposed at a position of about 60% or less of the effective radius with respect to the optical axis. In detail, the first critical point P1 may be disposed in a range of about 20% to about 50% of the effective radius of the first surface S1 with respect to the optical axis. In more detail, the first critical point P1 may be disposed in a range of about 30% to about 40% of the effective radius of the first surface S1 with respect to the optical axis. Here, the end of the first surface S1 may mean the end of the effective region of the first surface S1 of the first lens 110, and the position of the first critical point P1 may be a position set based on the vertical direction of the optical axis OA. The distance between the starting point, which is the optical axis of each lens surface, and the end or edge of the effective region represents the effective radius.

The position of the first critical point P1 preferably satisfies the above-described range in order to control the amount of light incident through the first lens 110. In addition, the position of the first critical point P1 preferably satisfies the above-described range in order to effectively control the path of light incident with a wide angle of view of about 110 degrees or more.

The second lens 120 may have positive (+) or negative (−) refractive power on the optical axis OA. The second lens 120 may include a plastic or glass material. For example, the second lens 120 may be made of a plastic material. The second lens 120 may include a third surface S3 defined as an object-side surface and a fourth surface S4 defined as a sensor-side surface. The third surface S3 may be convex on the optical axis OA, and the fourth surface S4 may be concave on the optical axis OA. That is, the second lens 120 may have a meniscus shape convex from the optical axis OA toward the object side. Alternatively, the third surface S3 may be convex on the optical axis OA, and the fourth surface S4 may be convex. That is, the second lens 120 may have a shape in which both sides are convex on the optical axis OA. Alternatively, the third surface S3 may have a concave shape on the optical axis OA, and the fourth surface S4 may be convex on the optical axis OA. That is, the second lens 120 may have a meniscus shape convex from the optical axis OA toward the sensor side. Alternatively, the third surface S3 may be concave on the optical axis OA, and the fourth surface S4 may be concave on the optical axis OA. That is, the second lens 120 may have a concave shape on both sides of the optical axis OA. At least one of the third surface S3 and the fourth surface S4 may be an aspherical surface. For example, both the third surface S3 and the fourth surface S4 may be aspherical.

The third lens 130 may have positive (+) or negative (−) refractive power on the optical axis OA. The third lens 130 may include a plastic or glass material. For example, the third lens 130 may be made of a plastic material. The third lens 130 may include a fifth surface S5 defined as an object-side surface and a sixth surface S6 defined as a sensor-side surface. The fifth surface S5 may be convex on the optical axis OA, and the sixth surface S6 may be concave on the optical axis OA. That is, the third lens 130 may have a meniscus shape convex toward the object side from the optical axis OA. Alternatively, the fifth surface S5 may be convex on the optical axis OA, and the sixth surface S6 may be convex on the optical axis OA. That is, the third lens 130 may have a shape in which both sides are convex on the optical axis OA. Alternatively, the fifth surface S5 may be concave on the optical axis OA, and the sixth surface S6 may be convex on the optical axis OA. That is, the third lens 130 may have a meniscus shape convex from the optical axis OA toward the sensor side. Alternatively, the fifth surface S5 may be concave on the optical axis OA, and the sixth surface S6 may be concave on the optical axis OA. That is, the third lens 130 may have a concave shape on both sides of the optical axis OA. At least one of the fifth surface S5 and the sixth surface S6 may be an aspherical surface. For example, both the fifth surface S5 and the sixth surface S6 may be aspherical.

The fourth lens 140 may have positive (+) refractive power on the optical axis OA. The fourth lens 140 may include a plastic or glass material. For example, the fourth lens 140 may be made of a plastic material. The fourth lens 140 may include a seventh surface S7 defined as an object-side surface and an eighth surface S8 defined as a sensor-side surface. The seventh surface S7 may be convex on the optical axis OA, and the eighth surface S8 may be convex on the optical axis OA. That is, the fourth lens 140 may have a shape in which both sides are convex on the optical axis OA. Alternatively, the seventh surface S7 may be concave on the optical axis OA, and the eighth surface S8 may be convex on the optical axis OA. That is, the fourth lens 140 may have a meniscus shape convex from the optical axis OA toward the sensor side. At least one of the seventh surface S7 and the eighth surface S8 may be an aspherical surface. For example, both the seventh surface S7 and the eighth surface S8 may be aspherical.

The fifth lens 150 may have negative (−) refractive power on the optical axis OA. The fifth lens 150 may include a plastic or glass material. For example, the fifth lens 150 may be made of a plastic material. The fifth lens 150 may include a ninth surface S9 defined as an object-side surface and a tenth surface S10 defined as a sensor-side surface. The ninth surface S9 may be convex on the optical axis OA, and the tenth surface S10 may be concave on the optical axis OA. That is, the fifth lens 150 may have a meniscus shape convex from the optical axis OA toward the object side. Alternatively, the ninth surface S9 may be concave on the optical axis OA, and the tenth surface S10 may be concave on the optical axis OA. That is, the fifth lens 150 may have a concave shape on both sides of the optical axis OA. At least one of the ninth surface S9 and the tenth surface S10 may be an aspherical surface. For example, both the ninth surface S9 and the tenth surface S10 may be aspherical.

The sixth lens 160 may have positive (+) or negative (−) refractive power on the optical axis OA. The sixth lens 160 may include a plastic or glass material. For example, the sixth lens 160 may be made of a plastic material. The sixth lens 160 may include an eleventh surface S11 defined as an object-side surface and a twelfth surface S12 defined as a sensor-side surface. The eleventh surface S11 may be convex on the optical axis OA, and the twelfth surface S12 may be concave on the optical axis OA. That is, the sixth lens 160 may have a meniscus shape convex from the optical axis OA toward the object side. Alternatively, the eleventh surface S11 may be convex on the optical axis OA, and the twelfth surface S12 may be convex on the optical axis OA. That is, the sixth lens 160 may have a shape in which both sides are convex on the optical axis OA. Alternatively, the eleventh surface S11 may be concave on the optical axis OA, and the twelfth surface S12 may be convex on the optical axis OA. That is, the sixth lens 160 may have a meniscus shape convex from the optical axis OA toward the sensor side. Alternatively, the eleventh surface S11 may be concave on the optical axis OA, and the twelfth surface S12 may be concave on the optical axis OA. That is, the sixth lens 160 may have a concave shape on both sides of the optical axis OA. At least one of the eleventh surface S11 and the twelfth surface S12 may be an aspherical surface. For example, both the eleventh surface S11 and the twelfth surface S12 may be aspherical.

The seventh lens 170 may have positive (+) or negative (−) refractive power on the optical axis OA. The seventh lens 170 may include a plastic or glass material. For example, the seventh lens 170 may be made of a plastic material. The seventh lens 170 may include a thirteenth surface S13 defined as an object-side surface and a fourteenth surface S14 defined as a sensor-side surface. The thirteenth surface S13 may be convex on the optical axis OA, and the fourteenth surface S14 may be concave on the optical axis OA. That is, the seventh lens 170 may have a meniscus shape convex from the optical axis OA toward the object side. Alternatively, the thirteenth surface S13 may be convex on the optical axis OA, and the fourteenth surface S14 may be convex on the optical axis OA. That is, the seventh lens 170 may have a shape in which both surfaces are convex. Alternatively, the thirteenth surface S13 may be concave on the optical axis OA, and the fourteenth surface S14 may be convex on the optical axis OA. That is, the seventh lens 170 may have a meniscus shape convex from the optical axis OA toward the sensor side. Alternatively, the thirteenth surface S13 may be concave on the optical axis OA, and the fourteenth surface S14 may be concave on the optical axis OA. That is, the seventh lens 170 may have a concave shape on both sides of the optical axis OA. At least one of the thirteenth surface S13 and the fourteenth surface S14 may be an aspherical surface. For example, both the thirteenth surface S13 and the fourteenth surface S14 may be aspherical.

The eighth lens 180 may have positive (+) refractive power on the optical axis OA. The eighth lens 180 may include a plastic or glass material. For example, the eighth lens 180 may be made of a plastic material. The eighth lens 180 may include a fifteenth surface S15 defined as an object-side surface and a sixteenth surface S16 defined as a sensor-side surface. The fifteenth surface S15 may be convex on the optical axis OA, and the sixteenth surface S16 may be convex on the optical axis OA. That is, the eighth lens 180 may have a shape in which both surfaces are convex. Alternatively, the fifteenth surface S15 may be concave on the optical axis OA, and the sixteenth surface S16 may be convex on the optical axis OA. That is, the eighth lens 180 may have a meniscus shape convex toward the sensor side. At least one of the fifteenth surface S15 and the sixteenth surface S16 may be an aspherical surface. For example, both the fifteenth surface S15 and the sixteenth surface S16 may be aspherical.

The ninth lens 190 may have a negative refractive power on the optical axis OA. The ninth lens 190 may include a plastic or glass material. For example, the ninth lens 190 may be made of a plastic material. The ninth lens 190 may include a seventeenth surface S17 defined as an object-side surface and an eighteenth surface S18 defined as a sensor-side surface. The seventeenth surface S17 may be convex on the optical axis OA, and the eighteenth surface S18 may be concave on the optical axis OA. That is, the ninth lens 190 may have a meniscus shape convex toward the object side from the optical axis OA. Alternatively, the seventeenth surface S17 may be concave on the optical axis OA, and the eighteenth surface S18 may be concave on the optical axis OA. That is, the ninth lens 190 may have a concave shape on both sides of the optical axis OA. At least one of the seventeenth surface S17 and the eighteenth surface S18 may be an aspherical surface. For example, both the seventeenth surface S17 and the eighteenth surface S18 may be aspherical.

The ninth lens 190 may include at least one critical point. In detail, at least one of the seventeenth surface S17 and the eighteenth surface S18 may include a critical point. For example, the seventeenth surface S17 may include a second critical point P2. When the optical axis OA is the starting point and the end of the seventeenth surface S17 of the ninth lens 190 is the end point, the second critical point P2 may be disposed at a position of about 60% or less of the effective radius of the seventeenth surface S17 with respect to the optical axis. In detail, the second critical point P2 may be disposed in a range of about 20% to about 50% of the effective radius of the seventeenth surface S17 with respect to the optical axis. In more detail, the second critical point P2 may be disposed in the range of about 30% to about 40% of the effective radius of the seventeenth surface S17 with respect to the optical axis. Here, the end of the seventeenth surface S17 may mean the end of the effective region of the seventeenth surface S17 of the ninth lens 190, and the position of the second critical point P2 may be a position set in a vertical direction to the optical axis OA.

The eighteenth surface S18 of the ninth lens 190 may include a third critical point P3. When the optical axis OA is the starting point and the end of the eighteenth surface S18 of the ninth lens 190 is the end point, the third critical point P3 may be disposed at a position of about 75% or less of the effective radius of the eighteenth surface S18 with respect to the optical axis. In detail, the third critical point P3 may be disposed in the range of about 40% to about 70% of the effective radius of the eighteenth surface S18 with respect to the optical axis. In more detail, the third critical point P3 may be disposed in a range of about 50% to about 60% of the effective radius of the eighteenth surface S18 with respect to the optical axis. Here, the end of the eighteenth surface S18 may mean the end of the effective region of the eighteenth surface S18 of the ninth lens 190, and the position of the third critical point P3 may be a position set in a vertical direction to the optical axis OA.

Each position of the second critical point P2 and the third critical point P3 may satisfy the above-described range in order to improve optical properties of the optical system 1000. In detail, the positions of the second and third critical points P2 and P3 preferably satisfy the above-described ranges for controlling optical characteristics such as aberration characteristics and resolution of the optical system 1000. That is, the ninth lens 190 may effectively control the path of light emitted to the image sensor 300 through the ninth lens 190 by the second and third critical points P2 and P3. Accordingly, the optical system 1000 according to the embodiment may have improved optical characteristics not only in the central portion of the field of view (FOV) but also in the peripheral portion.

The optical system 1000 according to the embodiment may satisfy at least one of the following equations. Accordingly, the optical system 1000 according to the embodiment may have improved resolution. In addition, since the optical system 1000 may effectively control distortion and aberration characteristics, it may have good optical performance not only at the center portion of the field of view but also at the periphery portion. In addition, the optical system 1000 may be provided in a slimmer and more compact structure.

Hereinafter, the above-described equations will be described.

$$1 < f 4 / F < 2 \qquad [ Equation 1 ]$$

In Equation 1, F means a total focal length (mm) of the optical system 1000, and f4 means a focal length (mm) of the fourth lens 140. When the optical system 1000 according to the embodiment satisfies Equation 1, the optical system 1000 may have improved resolution.

$$1.4 < nd 1 < 1.6 \qquad [ Equation 2 ]$$

In Equation 2, nd1 means a refractive index in the d-line of the first lens 110. When the optical system 1000 according to the embodiment satisfies Equation 2, it is possible to effectively control light incident with a large viewing angle.

$$10 < Vd 5 < 50 \qquad [ Equation 3 ]$$

In Equation 3, Vd5 means an Abbe number of the fifth lens 150. When the optical system 1000 according to the embodiment satisfies Equation 3, the optical system 1000 may have improved resolution.

$$1 < F / EPD < 3 \qquad [ Equation 4 ]$$

In Equation 4, F means a total focal length (mm) of the optical system 1000, and EPD means an entrance pupil size of the optical system 1000. When the optical system 1000 according to the embodiment satisfies Equation 4, the optical system 1000 may have improved brightness characteristics by controlling the incident light.

$$1 < L1\_CT / L5\_CT < 5 \qquad [ Equation 5 ]$$

In Equation 5, L1_CT means a thickness (mm) on the optical axis OA of the first lens 110, and L5_CT means a thickness (mm) on the optical axis OA of the fifth lens 150. When the optical system 1000 according to the embodiment satisfies Equation 5, the optical system 1000 may control distortion characteristics and thus minimize distortion.

$$1 < L8\_CT / L5\_CT < 5 \qquad [ Equation 6 ]$$

In Equation 6, L5_CT means a thickness (mm) on the optical axis OA of the fifth lens 150, and L8_CT means a thickness (mm) on the optical axis OA of the eighth lens 180. When the optical system 1000 according to the embodiment satisfies Equation 6, the optical system 1000 may control distortion characteristics, thereby minimizing distortion.

$$0.5 < \vert f 5 \vert / \vert f 4 \vert < 3 \qquad [ Equation 7 ]$$

In Equation 7, f4 means a focal length (mm) of the fourth lens 140, and f4 means a focal length (mm) of the fifth lens 150. When the optical system 1000 according to the embodiment satisfies Equation 7, the optical system 1000 may control the aberration characteristic, thereby minimizing the occurrence of aberration.

$$1 < CA\_L1S1 / CA\_L3S1 < 8 \qquad [ Equation 8 ]$$

In Equation 8, CA_L1S1 means an effective diameter (clear aperture (CA)) (mm) of the first object-side first surface S1 of the first lens 110, and CA_L3S1 means an effective diameter (mm) of an object-side fifth surface S5 of the third lens 130. When the optical system 1000 according to the embodiment satisfies Equation 8, the optical system 1000 may control the aberration characteristic, thereby minimizing the occurrence of aberration.

$$1 < CA\_L9S2 / CA\_L4S2 < 8 \qquad [ Equation 9 ]$$

In Equation 9, CA_L4S2 means the effective diameter (mm) of the sensor-side surface (eighth surface S8) of the fourth lens 140, and CA_L9S2 is the effective diameter (mm) of the sensor-side surface (eighteenth surface S18) of the ninth lens 190. When the optical system 1000 according to the embodiment satisfies Equation 9, the optical system 1000 may control the aberration characteristic, thereby minimizing the occurrence of aberration.

$$0.5 < d12\_CT / L1\_CT < 2 \qquad [ Equation 10 ]$$

In Equation 10, L1_CT means a thickness (mm) on the optical axis OA of the first lens 110, and d12_CT means a distance in the direction of the optical axis OA between a sensor-side surface (second surface S2) of the first lens 110 and the object-side surface (third surface S3) of the second lens 120. That is, L1_CT is a center thickness of the first lens 110, and d12_CT is a center distance between the first and second lenses 110 and 120. When the optical system 1000 according to the embodiment satisfies Equation 10, it is possible to effectively control light incident with a large viewing angle.

$$1.5 < CA\_L1S1 / CA\_L1S2 < 3 \qquad [ Equation 11 ]$$

In Equation 11, CA_L1S1 means the effective diameter (mm) of the object-side surface (first surface S1) of the first lens 110, and CA_L1S2 means the effective diameter (mm) of the sensor-side surface (second surface S2) of the first lens 110. When the optical system 1000 according to the embodiment satisfies Equation 11, it is possible to effectively control light incident with a large viewing angle.

$$2 < d12\_CT / d12\_ET < 3 \qquad [ Equation 12 ]$$

In Equation 12, d12_CT is a distance (mm) on the optical axis OA between the sensor-side surface (second surface S2) of the first lens 110 and the object-side surface (third surface S3) of the second lens 120. d12_ET is a distance (mm) in the direction of the optical axis OA between the first lens 110 and the second lens 120 at the end of the effective region of the object-side surface (third surface S3) of the second lens 120. That is, d12_ET is an edge interval between the first and second lenses 180 and 190. When the optical system 1000 according to the embodiment satisfies Equation 12, it is possible to effectively control light incident with a large viewing angle.

$$1 < d89\_CT / d89\_ET < 2.5 \qquad [ Equation 13 ]$$

In Equation 13, d89_CT means a distance on the optical axis OA between the sensor-side surface (sixteenth surface S16) of the eighth lens 180 and the object-side surface (seventeenth surface S17) of the ninth lens 190, d89_ET is a distance in the direction of the optical axis OA of the eighth lens 180 and the ninth lens 190 at the end of the effective region of the sensor-side surface (sixteenth surface S16) of the eighth lens 180. d89_CT is a center distance between the eighth and ninth lenses 180 and 190, and d89_ET is an edge distance between the eighth and ninth lenses 180 and 190. When the optical system 1000 according to the embodiment satisfies Equation 13, it may be obtained good optical performance at the periphery portion of the field of view (FOV). In detail, when Equation 13 is satisfied, excellent distortion and aberration characteristics may be obtained at the periphery portion of the field of view (FOV).

$$0.4 < L1\_CT / L1\_ET < 1 \qquad [ Equation 14 ]$$

In Equation 14, L1_CT means a thickness (mm) on the optical axis OA of the first lens 110, and L1_ET means a thickness in the direction of the optical axis OA at the end of the effective region of the first lens 110. In detail, L1_ET means the distance in the direction of the optical axis OA from the end of the effective region of the sensor-side surface (second surface S2) of the first lens 110 to the end of the effective region of the object-side surface (first surface S1) of the first lens 110. When the optical system 1000 according to the embodiment satisfies Equation 14, it is possible to effectively control light incident with a large viewing angle.

$$1. 5 < L8\_CT / L8\_ET < 3 \qquad [ Equation 15 ]$$

In Equation 15, L8_CT means a thickness (mm) on the optical axis OA of the eighth lens 180, and L8_ET means a thickness in the direction of the optical axis OA at the end of the effective region of the eighth lens 180. In detail, L8_ET means the distance in the direction of the optical axis (OA) from the end of the effective region of the sensor-side surface (sixteenth surface S16) of the eighth lens 180 to the end of the effective region of the object-side surface (fifteenth surface S15) of the eighth lens 180. When the optical system 1000 according to the embodiment satisfies Equation 15, it may have good distortion characteristics in the periphery of the field of view (FOV).

$$0.2 < L9\_CT / L9\_ET < 1 \qquad [ Equation 16 ]$$

In Equation 16, L9_CT means a thickness (mm) on the optical axis OA of the ninth lens 190, and L9_ET means a thickness in the optical axis OA direction at the end of the effective region of the ninth lens 190. In detail, L9_ET means the distance in the direction of the optical axis OA from the end of the effective region of the sensor-side surface (eighteenth surface S18) of the ninth lens 190 to the end of the effective region of the object-side surface (seventeenth surface S17) of the ninth lens 190. When the optical system 1000 according to the embodiment satisfies Equation 16, it may have good aberration characteristics in the periphery of the field of view (FOV).

$$3 < L 2 R 1 / d12\_CT < 6 \qquad [ Equation 17 ]$$

In Equation 17, L2R1 means a radius (mm) of curvature on the optical axis OA of the object-side surface (third surface S3) of the second lens 120, and d12_CT means a distance on the optical axis OA between the sensor-side surface (second surface S2) of the first lens 110 and the object-side surface (the third surface S3) of the second lens 120. When the optical system 1000 according to the embodiment satisfies Equation 17, it is possible to effectively control the light incident through the first lens 110 at a large viewing angle.

$$10 < L 7 R 1 / d78\_CT < 30 \qquad [ Equation 18 ]$$

In Equation 18, L7R1 means a radius (mm) of curvature on the optical axis OA of the object-side surface (thirteenth surface S13) of the seventh lens 170, and d78_CT means a distance on the optical axis OA between the sensor-side surface (fourteenth surface S14) of the seventh lens 170 and the object-side surface (fifteenth surface S15) of the eighth lens 180. When the optical system 1000 according to the embodiment satisfies Equation 18, it may have good chromatic aberration characteristics and distortion control characteristics in the periphery of the field of view (FOV).

$$1 \; 00 < \vert L 8 R 1 \vert / d89\_CT < 300 \qquad [ Equation 19 ]$$

In Equation 19, L8R1 means a radius (mm) of curvature on the optical axis OA of the object-side surface (fifteenth surface S15) of the eighth lens 180, and d89_CT means on the optical lens OA between the sensor-side surface (sixteenth surface S16) of the eighth lens 180 and the object-side surface (seventeenth surface S17) of the ninth lens 190. When the optical system 1000 according to the embodiment satisfies Equation 19, it may have good distortion control characteristics in the periphery of the field of view (FOV).

$$- 10 < L 1 R 1 / L1\_CT < - 2 \qquad [ Equation 20 ]$$

In Equation 20, L1R1 means a radius (mm) of curvature on the optical axis OA of the object-side surface (first surface S1) of the first lens 110, and L1_CT means the thickness (mm) of the first lens 110 on the optical axis OA. When the optical system 1000 according to the embodiment satisfies Equation 20, it is possible to effectively control the light incident through the first lens 110 at a large viewing angle.

$$5 < L 4 R 1 / L4\_CT < 20 \qquad [ Equation 21 ]$$

In Equation 21, L4R1 means a radius (mm) of curvature on the optical axis OA of the object-side surface (seventh surface S7) of the fourth lens 140, and L4_CT means a thickness (mm) of the fourth lens 140 on the optical axis OA. When the optical system 1000 according to the embodiment satisfies Equation 21, resolution may be improved and good optical characteristics may be obtained not only in the center portion of the field of view (FOV) but also in the periphery portion.

$$- 5 < L 4 R 2 / L4\_CT < - 1 \qquad [ Equation 22 ]$$

In Equation 22, L4R2 means a radius (mm) of curvature on the optical axis OA of the sensor-side surface (eighth surface S8) of the fourth lens 140, and L4_CT means a thickness (mm) of the fourth lens 140 on the optical axis OA. When the optical system 1000 according to the embodiment satisfies Equation 22, the resolution may be improved and good optical characteristics may be obtained not only in the center portion of the field of view (FOV) but also in the periphery portion.

$$5 \; 00 < \vert L 5 R 2 \vert / L5\_CT < 8500 \qquad [ Equation 23 ]$$

In Equation 23, L5R2 means a radius (mm) of curvature on the optical axis OA of the sensor-side surface (tenth surface S10) of the fifth lens 150, and L5_CT means a thickness (mm) of the fifth lens 150 on the optical axis OA. When the optical system 1000 according to the embodiment satisfies Equation 23, resolution may be improved and good optical characteristics may be obtained not only in the center portion of the field of view (FOV) but also in the periphery portion.

$$- 5 < L 1 R 1 / L 1 R 2 < - 1 \qquad [ Equation 24 ]$$

In Equation 24, L1R1 means a radius (mm) of curvature on the optical axis OA of the object-side surface (first surface S1) of the first lens 110, and L1R2 means a radius (mm) of curvature on the optical axis OA of the sensor-side surface (second surface S2) of the first lens 110. When the optical system 1000 according to the embodiment satisfies Equation 24, it is possible to effectively control light incident with a large viewing angle.

$$1 < T D 1 / T D 2 < 5 \qquad [ Equation 25 ]$$

In Equation 25, TD1 means a distance on the optical axis OA between the object-side surface (first surface S1) of the first lens 110 and the sensor-side surface (sixth surface S6) of the third lens 130. In addition, TD2 means a distance on the optical axis OA between the object-side surface (seventh surface S7) of the fourth lens 140 and the sensor-side surface (eighteenth surface S18) of the ninth lens 190. When the optical system 1000 according to the embodiment satisfies Equation 25, the optical system 1000 may have a large angle of view and may be provided in a slim and compact structure.

$$1 < CA\_max / ImgH < 3 \qquad [ Equation 26 ]$$

In Equation 26, CA_max means the largest effective diameter (clear aperture: CA) among the lens surfaces of the plurality of lenses 100 included in the optical system 1000. ImgH means twice the vertical distance (mm) with respect to the optical axis OA from a region of a field 0, which is the center of the upper surface of the image sensor 300 overlapping the optical axis OA, to a region of a field 1.0 of the image sensor 300. That is, the ImgH means the maximum diagonal length of the effective region of the image sensor 300. When the optical system 1000 according to the embodiment satisfies Equation 26, the optical system 1000 may be provided to be slim and compact structure. In addition, the optical system 1000 may implement high resolution and high image quality.

$$2 < CA\_max / CA\_Aver < 4 \qquad [ Equation 27 ]$$

In Equation 27, CA_max means the effective diameter (CA, mm) of the lens surface having the largest effective diameter (CA) size among the object-side surfaces and the sensor-side surfaces of the plurality of lenses 100. In addition, CA_Aver means an average of the effective diameter (CA, mm) of the object-side surfaces and the sensor-side surfaces of the plurality of lenses 100. When the optical system 1000 according to the embodiment satisfies Equation 27, the optical system 1000 may be provided in a slim and compact structure, and may have an appropriate size for realizing optical performance.

$$0.4 < CA\_min / Ca\_Aver < 1 \qquad [ Equation 28 ]$$

In Equation 28, CA_min means the effective diameter (CA, mm) of the lens surface having the smallest effective diameter (CA) among the object-side surfaces and the sensor-side surfaces of the plurality of lenses 100. In addition, CA_Aver means an average of the effective diameter (CA, mm) of the object-side surfaces and the sensor-side surfaces of the plurality of lenses 100. When the optical system 1000 according to the embodiment satisfies Equation 27, the optical system 1000 may be provided in a slim and compact structure, and may have an appropriate size for realizing optical performance.

$$0 < F < 30 \qquad [ Equation 29 ]$$

In Equation 29, F means the total focal length (mm) of the optical system 1000.

$$2 < TTL < 20 \qquad [ Equation 30 ]$$

In Equation 30, TTL (Total Track Length) means a distance on the optical axis OA from the vertex of the object-side surface (first surface S1) of the first lens 110 to the upper surface of the image sensor 300.

$$2 < ImgH \qquad [ Equation 31 ]$$

In Equation 31, ImgH means twice the vertical distance (mm) with respect to the optical axis OA from a region of a field 0, which is the center of the upper surface of the image sensor 300 overlapping the optical axis OA, to a region of a field 1.0 of the image sensor 300. That is, the ImgH means the maximum diagonal length (mm) of the effective region of the image sensor 300.

$$BFL < 2.5 \qquad [ Equation 32 ]$$

In Equation 32, BFL (Back focal length) means the distance (mm) from the vertex of the sensor-side surface of the lens closest to the image sensor 300 to the upper surface of the image sensor 300 on the optical axis OA.

$$110 degrees < F O V \qquad [ Equation 33 ]$$

In Equation 33, FOV means a field of view of the optical system 1000. In detail, the optical system 1000 according to the embodiment may have an angle of view of about 115 degrees or more. In more detail, the optical system 1000 may have an angle of view of about 120 degrees or more.

$$F \# < 3 \qquad [ Equation 34 ]$$

In Equation 34, F # means the F number of the optical system 1000.

$$0.2 < TTL / ImgH < 2 \qquad [ Equation 35 ]$$

In Equation 35, a relationship between total track length (TTL) and ImgH may be set. When the optical system 1000 according to the embodiment satisfies Equation 35, the optical system 1000 may secure the BFL for applying the image sensor 300 having a relatively large size, for example, the image sensor 300 having a size of about 1 inch or less, and may have a smaller TTL, and thus may have a high-definition and a high image quality and may provide a slim and compact structure.

$$BFL / ImgH < 0.5 \qquad [ Equation 36 ]$$

In Equation 36, a relationship between a back focal length (BFL) and ImgH may be established. When the optical system 1000 according to the embodiment satisfies Equation 36, the optical system 1000 may have a large angle of view and may apply an image sensor 300 having a relatively large size, for example, an image sensor 300 of about 1 inch or less, so that high-resolution and high image quality may be realized. In addition, since the distance between the last lens and the image sensor 300 may be minimized, good optical properties may be obtained at the center portion and the periphery portion of the field of view (FOV).

$$1 < TTL / BFL < 15 \qquad [ Equation 37 ]$$

In Equation 37, a relationship between total track length (TTL) and back focal length (BFL) may be established. When the optical system 1000 according to the embodiment satisfies Equation 37, the optical system 1000 may be provided in a slim and compact structure while securing the BFL.

$$0.01 < F / TTL < 1 \qquad [ Equation 38 ]$$

In Equation 38, a relationship between the total focal length F and a total track length (TTL) may be set. When the optical system 1000 according to the embodiment satisfies Equation 38, the optical system 1000 may be provided in a slim and compact structure.

$$0.5 < F / BFL < 3 \qquad [ Equation 39 ]$$

In Equation 39, a relationship between the total focal length F and the back focal length (BFL) may be established. When the optical system 1000 according to the embodiment satisfies Equation 39, the optical system 1000 may have a slim and compact structure at a set angle of view, and the distance between the last lens and the image sensor 300 may be minimized. Therefore, it is possible to have good optical properties at the periphery portion of the field of view (FOV).

$$F / ImgH < 0.95 \qquad [ Equation 40 ]$$

In Equation 40, a relationship between the overall focal length F and ImgH may be established. When the optical system 1000 according to the embodiment satisfies Equation 40, the optical system 1000 may have a large angle of view and may apply an image sensor 300 having a relatively large size, for example, an image sensor 300 of about 1 inch or less, so that high-resolution and high image quality may be realized.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + … \qquad [ Equation 41 ]$$

In Equation 41, Z is Sag, which may mean a distance in the optical axis direction from an arbitrary position on the aspherical surface to the vertex of the aspherical surface. Y may mean a distance in a direction perpendicular to the optical axis from any position on the aspherical surface to the optical axis. c may mean a curvature of a lens, and K may mean a conic constant. A, B, C, D, E, and F may mean an aspheric constant.

The optical system 1000 according to the embodiment may satisfy at least one or two or more of Equations 1 to 40. In this case, the optical system 1000 may have improved optical properties. In detail, when the optical system 1000 satisfies at least one of Equations 1 to 40, the optical system 1000 may have improved resolution and may improve aberration and peripheral distortion characteristics. When the optical system 1000 satisfies at least one of Equations 1 to 40, the optical system 1000 may include the image sensor 300 having a relatively large size and have a relatively small TTL value, and the optical system 1000 and a camera module including the same may have a slimmer and more compact structure.

In the optical system 1000 according to the embodiment, a distance between the plurality of lenses 100 may have a value set according to a region.

The first lens 110 and the second lens 120 may be spaced apart from each other by a first distance. The first distance may be an interval in a direction of an optical axis OA between the first lens 110 and the second lens 120. The first distance may vary according to a position between the first lens 110 and the second lens 120. In detail, when the optical axis OA is the starting point and the end of the object-side surface (third surface S3) of the second lens 120 is the endpoint, the first distance may vary from the optical axis OA toward a direction perpendicular to the optical axis OA. That is, the first distance may change from the optical axis OA toward the end of the effective diameter of the third surface S3. The first distance may decrease from the optical axis OA toward the first point EG1 positioned on the third surface S3. Here, the first point EG1 may be the end of the effective region of the third surface S3. The first distance may have a maximum value in the optical axis OA. Also, the first distance may have a minimum value at a first point EG1 located on the third surface S3. In this case, the maximum value of the first distance may be about twice or more than the minimum value. In detail, the maximum value of the first distance may satisfy about 2 times to about 3 times the minimum value. Accordingly, the optical system 1000 may effectively control the light incident through the first lens 110 at a large viewing angle.

The seventh lens 170 and the eighth lens 180 may be spaced apart from each other by a second distance. The second distance may be an interval in the direction of the optical axis OA between the seventh lens 170 and the eighth lens 180. The second distance may vary according to a position between the seventh lens 170 and the eighth lens 180. In detail, when the optical axis OA is the starting point and the end of the sensor-side surface (fourteenth surface S14) of the seventh lens 170 is the endpoint, the second distance may vary from the optical axis OA toward a direction perpendicular to the optical axis OA. That is, the second distance may change from the optical axis OA toward the end of the effective diameter of the fourteenth surface S14. The second distance may decrease from the optical axis OA toward the second point EG2 located on the fourteenth surface S14. When the optical axis OA is the starting point and the end of the fourteenth surface S14 is the end point, the second point EG2 may be disposed in the range of about 60% to about 85% of the effective radius of the fourteenth surface S14 with respect to the optical axis OA.

The second distance may increase from the second point EG2 in a direction perpendicular to the optical axis OA. For example, the second distance may increase from the second point EG2 to a third point EG3 located on the fourteenth surface S14. The third point EG3 is disposed more outside than the second point EG, and is disposed in the range of about 90% to 98% of the effective radius of the fourteenth surface S14 with respect to the optical axis OA. The second distance may decrease from the third point EG3 in a direction perpendicular to the optical axis OA. For example, the second distance may decrease from the third point EG3 to the fourth point EG4 positioned on the fourteenth surface S14. Here, the fourth point EG4 may be the end of the effective region of the fourteenth surface S14.

The second distance may have a maximum value on the optical axis OA and may have a minimum value at the end of the effective region of the fourteenth surface S14, that is, at the fourth point EG4. In this case, the maximum value of the second distance may be about twice or more than the minimum value. In detail, the maximum value of the second distance may satisfy about 2 times to about 3 times the minimum value. Accordingly, the optical system 1000 may have improved optical characteristics not only in the central portion of the field of view (FOV) but also in the peripheral portion. In detail, the optical system 1000 according to the embodiment may have improved distortion control characteristics as the seventh lens 170 and the eighth lens 180 are spaced apart at distances set according to positions.

The eighth lens 180 and the ninth lens 190 may be spaced apart from each other by a third distance. The third distance may be an interval in the direction of the optical axis OA between the eighth lens 180 and the ninth lens 190. The third distance may vary according to a position between the eighth lens 180 and the ninth lens 190. In detail, when the optical axis OA is the starting point and the end of the sensor-side surface (sixteenth surface S16) of the eighth lens 180 is the endpoint, the third distance may vary from the optical axis OA toward a direction perpendicular to the optical axis OA. That is, the third distance may change from the optical axis OA toward the end of the effective diameter of the sixteenth surface S16. The third distance may increase from the optical axis OA toward the fifth point EG5 located on the sixteenth surface S16. The fifth point EG5 may be disposed in the range of about 60% to about 80% of the effective radius of the sixteenth surface S16 with respect to the optical axis OA when the optical axis OA is the starting point and the end of the sixteenth surface S16 is the end point.

The third distance may decrease from the fifth point EG5 in a direction perpendicular to the optical axis OA. For example, the third distance may decrease from the fifth point EG5 to a sixth point EG6 located on the sixteenth surface S16. Here, the sixth point EG6 may be the end of the effective region of the sixteenth surface S16. The third distance may have a maximum value at the fifth point EG5 and a minimum value at the optical axis OA. In this case, the maximum value of the third distance may be about 5 times or more of the minimum value. In detail, the maximum value of the third distance may satisfy about 5 times to about 15 times the minimum value. Accordingly, the optical system 1000 may have improved optical properties not only in the central portion of the field of view (FOV) but also in the peripheral portion. In detail, the optical system 1000 according to the embodiment may have improved distortion control characteristics as the eighth lens 180 and the ninth lens 190 are spaced apart at distances set according to positions.

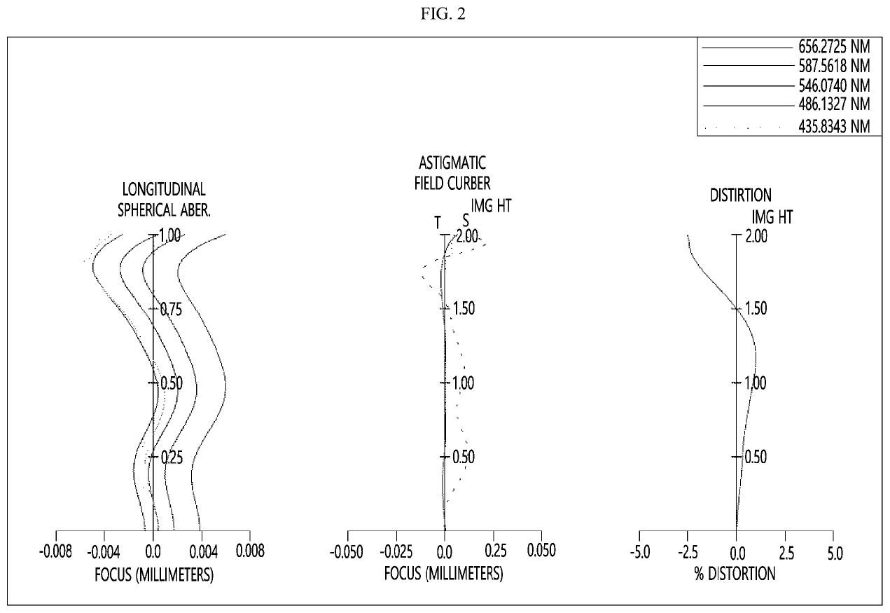

Hereinafter, the optical system 1000 according to the embodiment will be described in more detail with reference to the drawings. FIG. 1 is a configuration diagram of an optical system according to a first embodiment, and FIG. 2 is a graph illustrating aberration characteristics of the optical system according to the first embodiment.

Referring to FIGS. 1 and 2, the optical system 1000 according to the first embodiment may include the first lens 110, the second lens 120, the third lens 130 the fourth lens 140, the fifth lens 150, the sixth lens 160, the seventh lens 170, the eighth lens 180, the ninth lens 190 and the image sensor 300 sequentially arranged from the object side to the sensor side. The first to ninth lenses 110, 120, 130, 140, 150, 160, 170, 180 and 190 may be sequentially disposed along the optical axis OA of the optical system 1000. In the optical system 1000 according to the first embodiment, an aperture stop may be disposed between the third lens 130 and the fourth lens 140.

A filter 500 may be disposed between the plurality of lenses 100 and the image sensor 300. In detail, the filter 500 may be disposed between the ninth lens 190 and the image sensor 300.

TABLE 1

| | | | | | | | Effective |
|---|---|---|---|---|---|---|---|
| | | Radius of | Thickness (mm)/ | Reflective | Abbe | Effective | diameter |
| Lens | Surface | curvature | Distance (mm) | Index | number | radius(mm) | (mm) |
| Lens 1 | S1 | −4.175 | 0.792 | 1.5312 | 56.510 | 2.700 | 5.4 |
| | S2 | 1.669 | 0.840 | | 0 | 1.215 | 2.43 |
| Lens 2 | S3 | 3.831 | 0.837 | 1.6142 | 25.590 | 0.991 | 1.98 |
| | S4 | −7.284 | 0.137 | | 0 | 0.668 | 1.34 |
| Lens 3 | S5 | −1.618 | 0.232 | 1.5312 | 56.510 | 0.600 | 1.2 |
| | S6 | −1.733 | 0.030 | | 0 | 0.496 | 0.99 |
| Stop | | Infinity | 0.054 | | | 0.429 | 0.86 |
| Lens 4 | S7 | 6.904 | 0.492 | 1.5312 | 56.510 | 0.492 | 0.98 |
| | S8 | −1.010 | 0.090 | | 0 | 0.620 | 1.24 |
| Lens 5 | S9 | 260.975 | 0.220 | 1.6510 | 21.480 | 0.681 | 1.36 |
| | S10 | 1.509 | 0.032 | | 0 | 0.833 | 1.67 |
| Lens 6 | S11 | 2.584 | 0.284 | 1.5312 | 56.510 | 0.906 | 1.81 |
| | S12 | 4.265 | 0.062 | | 0 | 0.949 | 1.9 |
| Lens 7 | S13 | 2.541 | 0.444 | 1.5312 | 56.510 | 0.998 | 2 |
| | S14 | 3.462 | 0.116 | | 0 | 1.047 | 2.09 |
| Lens 8 | S15 | −5.886 | 0.576 | 1.5312 | 56.510 | 1.068 | 2.14 |
| | S16 | −0.820 | 0.030 | | 0 | 1.14 | 2.28 |
| Lens 9 | S17 | 1.900 | 0.400 | 1.6142 | 25.590 | 1.18 | 2.35 |
| | S18 | 0.747 | 0.195 | | 0 | 1.631 | 3.26 |
| Filter | | Infinity | 0.110 | | | 1.758 | 3.52 |
| | | Infinity | 0.415 | | | 1.792 | 3.58 |
| Image | | Infinity | −0.002 | | | 2.004 | 4.01 |
| sensor | | | | | | | |

Table 1 shows, in the first to ninth lenses 110, 120, 130, 140, 150, 160, 170, 180, and 190 according to the first embodiment, the radius of curvature on the optical axis, the center thickness of each lens, and the center distance between adjacent lenses, refractive index at d-line, Abbe number and the effective diameter (clear aperture (CA)). Referring to FIG. 1 and Table 1, in the optical system 1000 according to the first embodiment, the first lens 110 may have a negative refractive power on the optical axis OA. The first surface S1 of the first lens 110 may have a concave shape on the optical axis OA, and the second surface S2 may have a concave shape on the optical axis OA. The first lens 110 may have a concave shape on both sides of the optical axis OA. The first surface S1 may be an aspherical surface, and the second surface S2 may be an aspherical surface. The first surface S1 and the second surface S2 may have aspheric coefficients as shown in Table 2 below. The first lens 110 may have the largest effective diameter CA among the plurality of lenses 100. In detail, the first surface S1 of the first lens 110 may have the largest effective diameter (CA) among the first to eighteenth surfaces S1 to S18. The first lens 110 may include a critical point. In detail, the above-described first critical point P1 may be disposed on the first surface S1 of the first lens 110.

The second lens 120 may have a positive (+) refractive power on the optical axis OA. The third surface S3 of the second lens 120 may have a convex shape on the optical axis OA, and the fourth surface S4 may have a convex shape on the optical axis OA. The second lens 120 may have a shape in which both sides are convex on the optical axis OA. The third surface S3 may be an aspherical surface, and the fourth surface S4 may be an aspherical surface. The third surface S3 and the fourth surface S4 may have aspheric coefficients as shown in Table 2 below.

The third lens 130 may have negative (−) refractive power on the optical axis OA. The fifth surface S5 of the third lens 130 may have a concave shape on the optical axis OA, and the sixth surface S6 may be convex on the optical axis OA. The third lens 130 may have a meniscus shape convex from the optical axis OA toward the sensor side. The fifth surface S5 may be an aspherical surface, and the sixth surface S6 may be an aspherical surface. The fifth surface S5 and the sixth surface S6 may have aspheric coefficients as shown in Table 2 below.

The fourth lens 140 may have positive (+) refractive power on the optical axis OA. The seventh surface S7 of the fourth lens 140 may have a convex shape on the optical axis OA, and the eighth surface S8 may have a convex shape on the optical axis OA. The fourth lens 140 may have a shape in which both sides are convex on the optical axis OA. The seventh surface S7 may be an aspherical surface, and the eighth surface S8 may be an aspherical surface. The seventh surface S7 and the eighth surface S8 may have aspheric coefficients as shown in Table 2 below.

The fifth lens 150 may have negative (−) refractive power on the optical axis OA. The ninth surface S9 of the fifth lens 150 may have a convex shape on the optical axis OA, and the tenth surface S10 may have a concave shape on the optical axis OA. The fifth lens 150 may have a meniscus shape convex from the optical axis OA toward the object side. The ninth surface S9 may be an aspherical surface, and the tenth surface S10 may be an aspherical surface. The ninth surface S9 and the tenth surface S10 may have aspheric coefficients as shown in Table 2 below.

The sixth lens 160 may have a positive (+) refractive power on the optical axis OA. The eleventh surface S11 of the sixth lens 160 may have a convex shape along the optical axis OA, and the twelfth surface S12 may have a concave shape on the optical axis OA. The sixth lens 160 may have a meniscus shape convex from the optical axis OA toward the object side. The eleventh surface S11 may be an aspherical surface, and the twelfth surface S12 may be an aspherical surface. The eleventh surface S11 and the twelfth surface S12 may have aspheric coefficients as shown in Table 2 below.

The seventh lens 170 may have a positive (+) refractive power on the optical axis OA. The thirteenth surface S13 of the seventh lens 170 may have a convex shape on the optical axis OA, and the fourteenth surface S14 may have a concave shape on the optical axis OA. The seventh lens 170 may have a meniscus shape convex from the optical axis OA toward the object side. The thirteenth surface S13 may be an aspherical surface, and the fourteenth surface S14 may be an aspherical surface. The thirteenth surface S13 and the fourteenth surface S14 may have aspheric coefficients as shown in Table 2 below.

The eighth lens 180 may have positive (+) refractive power on the optical axis OA. The fifteenth surface S15 of the eighth lens 180 may have a concave shape on the optical axis OA, and the sixteenth surface S16 may have a convex shape on the optical axis OA. The eighth lens 180 may have a meniscus shape convex from the optical axis OA toward the sensor side. The fifteenth surface S15 may be an aspherical surface, and the sixteenth surface S16 may be an aspherical surface. The fifteenth surface S15 and the sixteenth surface S16 may have aspheric coefficients as shown in Table 2 below.

The ninth lens 190 may have a negative refractive power on the optical axis OA. The seventeenth surface S17 of the ninth lens 190 may have a convex shape on the optical axis OA, and the eighteenth surface S18 may have a concave shape on the optical axis OA. The ninth lens 190 may have a meniscus shape convex from the optical axis OA toward the object side. The seventeenth surface S17 may be an aspherical surface, and the eighteenth surface S18 may be an aspherical surface. The seventeenth surface S17 and the eighteenth surface S18 may have aspheric coefficients as shown in Table 2 below.

The ninth lens 190 may include a critical point. In detail, the above-described second critical point P2 may be disposed on the seventeenth surface S17 of the ninth lens 190. In addition, the above-described third critical point P3 may be disposed on the eighteenth surface S18 of the ninth lens 190.

Table 2 below shows the values of the aspheric coefficients of each lens surface in the optical system 1000 according to the first embodiment.

TABLE 2

| | L1 | | L2 | | L3 | | L4 | | L5 |
|---|---|---|---|---|---|---|---|---|---|
| | S1 | S2 | S3 | S4 | S5 | S6 | S7 | S8 | S9 |
| K | 4.01E−01 | 1.54E−02 | 8.45E+00 | 9.50E+01 | −1.21E+00 | −6.05E+00 | 7.39E+01 | 8.25E−01 | −9.50E+01 |
| A | 1.18E−01 | 1.31E−01 | −6.68E−02 | 7.23E−02 | 7.58E−02 | 5.83E−02 | 6.68E−02 | 3.59E−01 | −1.74E−01 |
| B | −5.70E−02 | 1.91E−01 | 1.64E−01 | −1.83E−01 | 4.06E−02 | 5.07E−01 | −3.65E+00 | −2.75E+00 | −1.37E+00 |
| C | 2.45E−02 | −5.80E−01 | −9.61E−01 | 6.33E−01 | 1.68E−01 | −8.66E−01 | 8.29E+01 | 1.80E+01 | 3.94E+00 |
| D | −8.05E−03 | 1.26E+00 | 2.57E+00 | −6.58E+00 | 9.49E−01 | 3.55E+00 | −1.24E+03 | −1.15E+02 | −4.20E+00 |
| E | 1.90E−03 | −1.71E+00 | −4.66E+00 | 3.47E+01 | 2.15E−11 | 2.18E−11 | 1.15E+04 | 6.03E+02 | −1.59E+01 |
| F | −3.09E−04 | 1.44E+00 | 4.85E+00 | 9.36E+01 | 6.30E−12 | 6.32E−12 | 6.78E+04 | 2.25E+03 | 9.44E+01 |
| G | 3.28E−05 | −7.04E−01 | −2.60E+00 | 1.53E+02 | 1.83E−12 | 1.83E−12 | 2.44E+05 | 5.31E+03 | −2.34E+02 |
| H | −2.03E−06 | 1.45E−01 | 5.62E−01 | 1.39E+02 | 5.27E−13 | 5.27E−13 | −4.94E+05 | 6.98E+03 | 2.96E+02 |
| I | 5.60E−08 | 0.00E+00 | −1.47E−16 | 5.63E+01 | 1.52E−13 | 1.52E−13 | 4.29E+05 | 3.83E+03 | −1.56E+02 |
| | L5 | L6 | | L7 | | L8 | | L9 | |
| | S10 | S11 | S12 | S13 | S14 | S15 | S16 | S17 | S18 |
| K | 1.51E−01 | 7.13E−01 | −1.23E+01 | −4.86E+01 | −9.50E+01 | 1.83E+01 | −7.99E−01 | −2.73E−01 | −3.56E+00 |
| A | −4.72E−01 | 4.17E−03 | −9.08E−03 | −7.45E−02 | 5.90E−02 | 5.20E−01 | 4.73E−01 | −8.12E−01 | −7.52E−01 |
| B | 1.26E+00 | 1.01E−02 | 3.03E−02 | 6.62E−02 | −1.26E+00 | −2.04E+00 | 1.30E+00 | −4.05E−01 | 1.39E+00 |
| C | −5.66E+00 | 3.68E−02 | 1.74E−02 | 1.39E+00 | 2.62E+00 | 3.84E+00 | 4.70E+00 | 4.61E+00 | −1.86E+00 |
| D | 1.94E+01 | −2.56E−02 | −3.70E−03 | −4.86E+00 | −3.17E+00 | −6.74E+00 | −1.13E+01 | 1.10E+01 | 1.75E+00 |
| E | 4.26E+01 | 1.98E−13 | −4.99E−13 | 8.27E+00 | 3.50E+00 | 1.13E+01 | 1.70E+01 | 1.40E+01 | 1.17E+00 |
| F | 5.63E+01 | −1.02E−14 | −3.38E−14 | −8.07E+00 | −2.94E+00 | −1.22E+01 | −1.64E+01 | −1.05E+01 | 5.34E−01 |
| G | −4.14E+01 | −4.78E−15 | −7.58E−15 | 4.19E+00 | 1.03E+00 | 7.24E+00 | 1.02E+01 | 4.53E+00 | −1.59E−01 |
| H | 1.29E+01 | 0.00E+00 | 0.00E+00 | −8.76E−01 | −1.13E−15 | −2.18E+00 | −3.87E+00 | −1.02E+00 | 2.77E−02 |
| I | −1.59E−16 | 0.00E+00 | 0.00E+00 | 0.00E+00 | −1.48E−16 | 2.81E−01 | 6.66E−01 | 8.58E−02 | −2.12E−03 |

In addition, in the optical system 1000 according to the first embodiment, the first distance d12 between the sensor-side surface of the first lens 110 and the object-side surface of the second lens 120 from the optical axis toward a direction perpendicular to the optical axis may be as shown in Table 3 below.

TABLE 3

| Vertical height (mm) of the | | Vertical height (mm) of the |
|---|---|---|
| optical axis from the optical | | optical axis from the optical |
| axis at the sensor-side surface | | axis at the object-side surface |
| of the first lens | First distance (d12) (mm) | of the second lens |
| 0 | 0.8400 | 0 |
| 0.1 | 0.8383 | 0.1 |
| 0.2 | 0.8329 | 0.2 |
| 0.3 | 0.8231 | 0.3 |
| 0.4 | 0.8074 | 0.4 |
| 0.5 | 0.7838 | 0.5 |
| 0.6 | 0.7488 | 0.6 |
| 0.7 | 0.6971 | 0.7 |
| 0.8 | 0.6206 | 0.8 |
| 0.9 | 0.5099 | 0.9 |
| 0.991(EG1) | 0.3613 | 0.991 (EG1) |

Referring to Table 3, the first distance may be reduced from the optical axis OA to the first point EG1 located on the third surface S3. The first point EG1 may be the end of the effective diameter of the second lens 120. Here, the value of the first point EG1 may mean an effective radius value of the third surface S3 having a smaller effective diameter of the sensor-side surface (second surface S2) of the first lens 110 and the object-side surface (third surface S3) of the second lens 120 facing each other, and means an effective radius value of the third surface S3 shown in Table 1. The first distance may have a maximum value at an optical axis OA and a minimum value at the first point EG1. The maximum value of the first distance may be about 2 to about 3 times the minimum value. In an embodiment, the maximum value of the first distance may be about 2.32 times the minimum value. In the optical system 1000 according to the first embodiment, the first lens 110 and the second lens 120 may have the first distance along a region. Accordingly, the optical system 1000 may effectively control the light incident through the first lens 110 at a large viewing angle. In the optical system 1000 according to the first embodiment, a second distance d78 between the sensor-side surface of the seventh lens 170 and the object-side surface of the eighth lens 180 in a direction perpendicular to the optical axis with respect to the optical axis may be as shown in Table 4 below.

TABLE 4

| Vertical height (mm) of the | | Vertical height (mm) of the |
|---|---|---|
| optical axis from the optical | | optical axis from the optical |
| axis at the sensor-side surface | | axis on the object-side surface |
| of the seventh lens | Second distance (d78) (mm) | of the eighth lens |
| 0.000 | 0.1160 | 0.000 |
| 0.100 | 0.1137 | 0.100 |
| 0.200 | 0.1079 | 0.200 |
| 0.300 | 0.1002 | 0.300 |
| 0.400 | 0.0927 | 0.400 |
| 0.500 | 0.0868 | 0.500 |
| 0.600 | 0.0821 | 0.600 |
| 0.700 | 0.0775 | 0.700 |
| 0.800(EG2) | 0.0732 | 0.800 (EG2) |
| 0.900 | 0.0742 | 0.900 |
| 1.000(EG3) | 0.0855 | 1.000 (EG3) |
| 1.047(EG4) | 0.0511 | 1.047 (EG4) |

Referring to Table 4, the second distance may decrease from the optical axis OA toward the second point EG2 located on the fourteenth surface S14. When the optical axis OA is the starting point and the end point of the effective region of the fourteenth surface S14 is the end point, the second point EG2 may be disposed in the range of about 60% to about 85% of the effective radius of the fourteenth surface S14 with respect to the optical axis OA. For example, in the first embodiment, the second point EG2 may be disposed at a position that is about 76.4% of the effective radius of the fourteenth surface S14 with respect to the optical axis OA. The second distance may increase from the second point EG2 to the third point EG3 positioned on the fourteenth surface S14. The third point EG3 may be disposed in a range of about 90% to about 98% of an effective radius of the fourteenth surface S14 with respect to the optical axis OA. For example, in the first embodiment, the third point EG3 may be disposed at a position that is about 95.5% of the effective radius of the fourteenth surface S14 with respect to the optical axis OA. The second distance may decrease from the third point EG3 to the fourth point EG4 that is the end of the effective diameter of the fourteenth surface S14. Here, the value of the fourth point EG4 is an effective radius value of the fourteenth surface S14 having a smaller effective diameter among the sensor-side surface (fourteenth surface S14) of the seventh lens 170 and the object-side surface (fifteenth surface S15) of the eighth lens 180 facing each other, and means an effective radius value of the fourteenth surface S14 described in Table 1. The second distance may have a maximum value at the optical axis OA and a minimum value at the fourth point EG4. The maximum value of the second distance may be about 2 times to about 3 times the minimum value. For example, in the first embodiment, the maximum value of the second distance may be about 2.27 times the minimum value. Accordingly, the optical system 1000 may have improved optical characteristics not only in the central portion of the field of view (FOV) but also in the peripheral portion. In detail, the optical system 1000 according to the embodiment may have improved distortion control characteristics as the seventh lens 170 and the eighth lens 180 are spaced apart at distances set according to positions.

In the optical system 1000 according to the first embodiment, a third distance d89 between the sensor-side surface of the eighth lens 180 and the object-side surface of the ninth lens 190 in a direction perpendicular to the optical axis with respect to the optical axis may be as shown in Table 5 below.

TABLE 5

| Vertical height (mm) of the | | Vertical height (mm) of the |
|---|---|---|
| optical axis from the optical | | optical axis from the optical |
| axis at the sensor side of the | | axis on the object side of the |
| eighth lens | Third distance (d89) (mm) | ninth lens |
| 0.000 | 0.0300 | 0.000 |
| 0.100 | 0.0386 | 0.100 |
| 0.200 | 0.0630 | 0.200 |
| 0.300 | 0.0993 | 0.300 |
| 0.400 | 0.1419 | 0.400 |
| 0.500 | 0.1851 | 0.500 |
| 0.600 | 0.2242 | 0.600 |
| 0.700 | 0.2552 | 0.700 |
| 0.800 (EG5) | 0.2735 | 0.800 (EG5) |
| 0.900 | 0.2697 | 0.900 |
| 1.000 | 0.2301 | 1.000 |
| 1.14(EG6) | 0.1518 | 1.14 (EG6) |

Referring to Table 5, the third distance may increase from the optical axis OA toward a fifth point EG5 located on the sixteenth surface S16. When the optical axis OA is the starting point and the end point of the effective region of the sixteenth surface S16 is the end point, the fifth point EG5 may be disposed in the range of about 60% to about 80% of the effective radius of the sixteenth surface S16 with respect to the optical axis OA. For example, in the first embodiment, the fifth point EG5 may be disposed at a position that is about 70.2% of the effective radius of the sixteenth surface S16 with respect to the optical axis OA. Also, the third distance may decrease from the fifth point EG5 toward the sixth point EG6 which is the end of the effective diameter of the sixteenth surface S16. Here, the value of the sixth point EG6 is an effective radius value of the sixteenth surface S16 having a smaller effective diameter of the sensor-side surface (sixteenth surface S16) of the eighth lens 180 and the object-side surface (seventeenth surface S17) of the ninth lens 190 facing each other, and means an effective radius value of the sixteenth surface S16 described in Table 1. The third distance may have a maximum value at the fifth point EG5 and a minimum value at the optical axis OA. The maximum value of the third distance may be about 5 times to about 15 times the minimum value. For example, in the first embodiment, the maximum value of the second distance may be about 9.1 times the minimum value. Accordingly, the optical system 1000 may have improved optical characteristics not only in the central portion of the field of view (FOV) but also in the peripheral portion. In detail, the optical system 1000 according to the embodiment may have improved distortion control characteristics as the eighth lens 180 and the ninth lens 190 are spaced apart at distances set according to positions. The optical system 1000 according to the first embodiment may have good optical performance at the center portion and the periphery portion of the field of view (FOV), and may have aberration characteristics as shown in FIG. 2.

The optical system 1000 according to the first embodiment has improved resolution and may effectively control light incident at a large viewing angle. In addition, the optical system 1000 may have a smaller TTL and may be provided in a slim and compact structure. In addition, the optical system 1000 may have good optical performance at the center portion and the periphery portion of the field of view (FOV), and may have aberration characteristics as shown in FIG. 2.

In detail, FIG. 2 is a graph of the aberration characteristics of the optical system 1000 according to the first embodiment, in which spherical aberration (Longitudinal spherical aberration), astigmatic field curves, and distortion are measured from left to right. In FIG. 2, the X-axis may indicate a focal length (mm) or distortion (%), and the Y-axis may indicate the height of an image. In addition, the graph for spherical aberration is a graph for light in a wavelength band of about 436 nm, about 486 nm, about 546 nm, about 587 nm (d-line), and about 656 nm, and the graph for astigmatism and distortion aberration is a graph for light in the wavelength band of 587 nm. That is, referring to FIG. 2, the optical system 1000 according to the first embodiment may have excellent aberration and distortion characteristics in a wide angle of view improved as the plurality of lenses 100 have a set shape and focal length. In addition, the optical system 1000 may provide good optical performance not only at the center portion of the field of view (FOV) but also at the periphery portion.

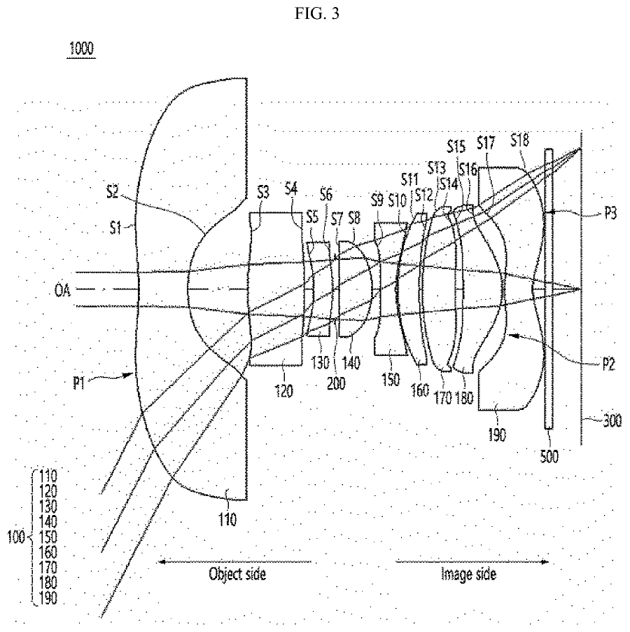

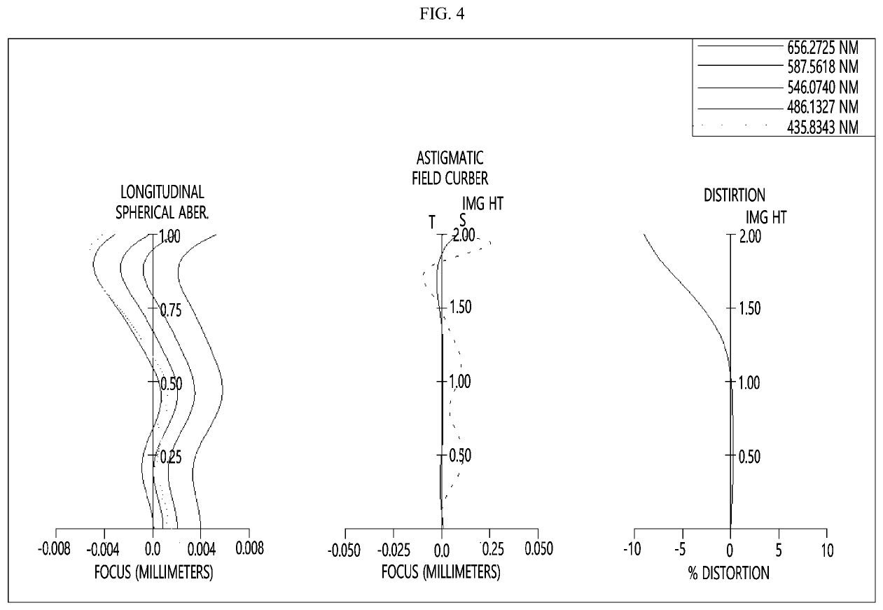

FIG. 3 is a configuration diagram of an optical system according to a second embodiment, and FIG. 4 is a graph illustrating aberration characteristics of the optical system according to the second embodiment.

Referring to FIGS. 3 and 4, the optical system 1000 according to the second embodiment may include the first lens 110, the second lens 120, the third lens 130 the fourth lens 140, the fifth lens 150, the sixth lens 160, the seventh lens 170, the eighth lens 180, the ninth lens 190 and the image sensor 300 sequentially arranged from the object side to the sensor side. The first to ninth lenses 110, 120, 130, 140, 150, 160, 170, 180 and 190 may be sequentially disposed along the optical axis OA of the optical system 1000. In the optical system 1000 according to the second embodiment, an aperture stop may be disposed between the third lens 130 and the fourth lens 140.

A filter 500 may be disposed between the plurality of lenses 100 and the image sensor 300. In detail, the filter 500 may be disposed between the ninth lens 190 and the image sensor 300.

TABLE 6

| | | | | | | | Effective |
|---|---|---|---|---|---|---|---|
| | | Radius of | Thickness(mm)/ | Reflective | Abbe | Effective | diameter |
| Lens | Surface | curvature | Distance(mm) | Index | number | radius(mm) | (mm) |
| Lens 1 | S1 | −4.294 | 0.706 | 1.5312 | 56.5100 | 2.700 | 5.40 |
| | S2 | 1.568 | 0.863 | | | 1.222 | 2.44 |
| Lens 2 | S3 | 3.907 | 0.812 | 1.6142 | 25.5900 | 0.982 | 1.96 |
| | S4 | −7.360 | 0.135 | | | 0.673 | 1.35 |
| Lens 3 | S5 | −1.659 | 0.275 | 1.5312 | 56.5100 | 0.604 | 1.21 |
| | S6 | −1.822 | 0.030 | | | 0.481 | 0.96 |
| Stop | | Infinity | 0.060 | | | 0.420 | 0.84 |
| Lens 4 | S7 | 6.904 | 0.477 | 1.5312 | 56.5100 | 0.489 | 0.98 |
| | S8 | −1.002 | 0.120 | | | 0.614 | 1.23 |
| Lens 5 | S9 | 1793.681 | 0.220 | 1.6510 | 21.4800 | 0.688 | 1.38 |
| | S10 | 1.424 | 0.030 | | | 0.851 | 1.70 |
| Lens 6 | S11 | 2.504 | 0.304 | 1.5312 | 56.5100 | 0.926 | 1.85 |
| | S12 | 4.317 | 0.042 | | | 0.971 | 1.94 |
| Lens 7 | S13 | 2.231 | 0.469 | 1.5312 | 56.5100 | 1.016 | 2.03 |
| | S14 | 3.117 | 0.122 | | | 1.056 | 2.11 |
| Lens 8 | S15 | −5.542 | 0.564 | 1.5312 | 56.5100 | 1.080 | 2.16 |
| | S16 | −0.801 | 0.030 | | | 1.14 | 2.29 |
| Lens 9 | S17 | 1.863 | 0.403 | 1.6142 | 25.5900 | 1.18 | 2.36 |
| | S18 | 0.769 | 0.179 | | | 1.631 | 3.26 |
| Filter | | Infinity | 0.110 | | | 1.759 | 3.52 |
| | | Infinity | 0.406 | | | 1.793 | 3.59 |
| Image | | Infinity | −0.001 | | | 2.000 | 4.00 |
| sensor | | | | | | | |

Table 6 shows, in the first to ninth lenses 110, 120, 130, 140, 150, 160, 170, 180, and 190 according to the second embodiment, the radius of curvature on the optical axis, the center thickness of each lens, and the center distance between adjacent lenses, refractive index at d-line, Abbe number and the effective diameter (clear aperture (CA)). Referring to FIG. 3 and table 6, in the optical system 1000 according to the second embodiment, the first lens 110 may have a negative refractive power on the optical axis OA. The first surface S1 of the first lens 110 may have a concave shape on the optical axis OA, and the second surface S2 may have a concave shape on the optical axis OA. The first lens 110 may have a concave shape on both sides of the optical axis OA. The first surface S1 may be an aspherical surface, and the second surface S2 may be an aspherical surface. The first surface S1 and the second surface S2 may have aspheric coefficients as shown in Table 7 below. The first lens 110 may have the largest effective diameter (CA) among the plurality of lenses 100. In detail, the first surface S1 of the first lens 110 may have the largest effective diameter (CA) among the first to eighteenth surfaces S1 to S18. The first lens 110 may include a critical point. In detail, the above-described first critical point P1 may be disposed on the first surface S1 of the first lens 110.

The second lens 120 may have a positive (+) refractive power on the optical axis OA. The third surface S3 of the second lens 120 may have a convex shape on the optical axis OA, and the fourth surface S4 may have a convex shape on the optical axis OA. The second lens 120 may have a shape in which both sides are convex on the optical axis OA. The third surface S3 may be an aspherical surface, and the fourth surface S4 may be an aspherical surface. The third surface S3 and the fourth surface S4 may have aspheric coefficients as shown in Table 7 below.

The third lens 130 may have negative (−) refractive power on the optical axis OA. The fifth surface S5 of the third lens 130 may have a concave shape on the optical axis OA, and the sixth surface S6 may be convex on the optical axis OA. The third lens 130 may have a meniscus shape convex from the optical axis OA toward the sensor side. The fifth surface S5 may be an aspherical surface, and the sixth surface S6 may be an aspherical surface. The fifth surface S5 and the sixth surface S6 may have aspheric coefficients as shown in Table 7 below.

The fourth lens 140 may have positive (+) refractive power on the optical axis OA. The seventh surface S7 of the fourth lens 140 may have a convex shape on the optical axis OA, and the eighth surface S8 may have a convex shape on the optical axis OA. The fourth lens 140 may have a shape in which both sides are convex on the optical axis OA. The seventh surface S7 may be an aspherical surface, and the eighth surface S8 may be an aspherical surface. The seventh surface S7 and the eighth surface S8 may have aspheric coefficients as shown in Table 7 below.

The fifth lens 150 may have negative (−) refractive power on the optical axis OA. The ninth surface S9 of the fifth lens 150 may have a convex shape on the optical axis OA, and the tenth surface S10 may have a concave shape on the optical axis OA. The fifth lens 150 may have a meniscus shape convex from the optical axis OA toward the object side. The ninth surface S9 may be an aspherical surface, and the tenth surface S10 may be an aspherical surface. The ninth surface S9 and the tenth surface S10 may have aspheric coefficients as shown in Table 7 below.

The sixth lens 160 may have a positive (+) refractive power on the optical axis OA. The eleventh surface S11 of the sixth lens 160 may have a convex shape along the optical axis OA, and the twelfth surface S12 may have a concave shape on the optical axis OA. The sixth lens 160 may have a meniscus shape convex from the optical axis OA toward the object side. The eleventh surface S11 may be an aspherical surface, and the twelfth surface S12 may be an aspherical surface. The eleventh surface S11 and the twelfth surface S12 may have aspheric coefficients as shown in Table 7 below.

The seventh lens 170 may have a positive (+) refractive power on the optical axis OA. The thirteenth surface S13 of the seventh lens 170 may have a convex shape on the optical axis OA, and the fourteenth surface S14 may have a concave shape on the optical axis OA. The seventh lens 170 may have a meniscus shape convex from the optical axis OA toward the object side. The thirteenth surface S13 may be an aspherical surface, and the fourteenth surface S14 may be an aspherical surface. The thirteenth surface S13 and the fourteenth surface S14 may have aspherical coefficients as shown in Table 7 below.

The eighth lens 180 may have positive (+) refractive power on the optical axis OA. The fifteenth surface S15 of the eighth lens 180 may have a concave shape on the optical axis OA, and the sixteenth surface S16 may have a convex shape on the optical axis OA. The eighth lens 180 may have a meniscus shape convex from the optical axis OA toward the sensor side. The fifteenth surface S15 may be an aspherical surface, and the sixteenth surface S16 may be an aspherical surface. The fifteenth surface S15 and the sixteenth surface S16 may have aspheric coefficients as shown in Table 7 below.

The ninth lens 190 may have a negative refractive power on the optical axis OA. The seventeenth surface S17 of the ninth lens 190 may have a convex shape on the optical axis OA, and the eighteenth surface S18 may have a concave shape on the optical axis OA. The ninth lens 190 may have a meniscus shape convex from the optical axis OA toward the object side. The seventeenth surface S17 may be an aspherical surface, and the eighteenth surface S18 may be an aspherical surface. The seventeenth surface S17 and the eighteenth surface S18 may have aspheric coefficients as shown in Table 7 below. The ninth lens 190 may include a critical point. In detail, the above-described second critical point P2 may be disposed on the seventeenth surface S17 of the ninth lens 190. In addition, the above-described third critical point P3 may be disposed on the eighteenth surface S18 of the ninth lens 190.

Table 7 below shows the values of the aspheric coefficients of each lens surface in the optical system 1000 according to the second embodiment.

TABLE 7

| | L1 | | L2 | | L3 | | L4 | | L5 |
|---|---|---|---|---|---|---|---|---|---|
| | S1 | S2 | S3 | S4 | S5 | S6 | S7 | S8 | S9 |
| K | 5.97E−01 | −1.22E−01 | 9.61E+00 | 9.21E+01 | −8.92E−01 | −7.59E+00 | 5.72E+01 | 8.32E−01 | −9.50E+01 |
| A | 1.17E−01 | 1.12E−01 | −7.72E−02 | 4.32E−02 | 6.96E−02 | 6.93E−02 | 6.40E−02 | 3.53E−01 | −1.49E−01 |
| B | −5.71E−02 | 2.10E−01 | 1.60E−01 | −1.70E−01 | 5.62E−02 | 4.61E−01 | −3.73E+00 | −2.69E+00 | −1.39E+00 |
| C | 2.45E−02 | −6.20E−01 | −9.63E−01 | 6.88E−01 | 7.59E−02 | −7.96E−01 | 8.30E+01 | 1.79E+01 | 3.98E+00 |
| D | −8.05E−03 | 1.32E+00 | 2.58E+00 | −6.73E+00 | 1.04E+00 | 4.14E+00 | −1.24E+03 | −1.15E+02 | −4.20E+00 |
| E | 1.90E−03 | −1.77E+00 | −4.66E+00 | 3.47E+01 | 2.16E−11 | 2.19E−11 | 1.15E+04 | 6.03E+02 | −1.59E+01 |
| F | −3.09E−04 | 1.48E+00 | 4.85E+00 | −9.36E+01 | 6.32E−12 | 6.34E−12 | −6.78E+04 | −2.25E+03 | 9.44E+01 |
| G | 3.28E−05 | −7.06E−01 | −2.60E+00 | 1.53E+02 | 1.83E−12 | 1.83E−12 | 2.44E+05 | 5.31E+03 | 2.34E+02 |
| H | −2.03E−06 | 1.42E−01 | 5.62E−01 | −1.39E+02 | 5.28E−13 | 5.28E−13 | −4.94E+05 | −6.98E+03 | 2.96E+02 |
| I | 5.60E−08 | −3.63E−18 | −6.69E−17 | 5.63E+01 | 1.52E−13 | 1.52E−13 | 4.29E+05 | 3.83E+03 | −1.56E+02 |
| | L5 | L6 | | L7 | | L8 | | L9 | |
| | S10 | S11 | S12 | S13 | S14 | S15 | S16 | S17 | S18 |
| K | 8.78E−02 | 8.32E−01 | −2.01E+01 | −4.14E+01 | −9.36E+01 | 1.67E+01 | −8.12E−01 | −1.05E−01 | −3.64E+00 |
| A | −4.77E−01 | 4.84E−03 | −1.07E−02 | −7.33E−02 | 4.35E−02 | 5.12E−01 | 4.82E−01 | −8.09E−01 | −7.51E−01 |
| B | 1.25E+00 | 9.05E−03 | 3.25E−02 | 6.46E−02 | 1.27E+00 | −2.04E+00 | −1.29E+00 | −4.11E−01 | 1.39E+00 |
| C | −5.67E+00 | 3.27E−02 | 1.99E−02 | 1.39E+00 | 2.63E+00 | 3.84E+00 | 4.70E+00 | 4.61E+00 | −1.86E+00 |
| D | 1.95E+01 | −2.78E−02 | −1.46E−02 | −4.86E+00 | 3.16E+00 | −6.74E+00 | −1.13E+01 | −1.10E+01 | 1.75E+00 |
| E | 4.26E+01 | 2.20E−13 | −3.19E−13 | 8.27E+00 | 3.50E+00 | 1.13E+01 | 1.70E+01 | 1.40E+01 | −1.17E+00 |
| F | 5.63E+01 | 1.14E−15 | −1.51E−14 | −8.07E+00 | −2.94E+00 | −1.22E+01 | −1.64E+01 | −1.05E+01 | 5.34E−01 |
| G | −4.14E+01 | −2.40E−15 | −4.74E−15 | 4.19E+00 | 1.03E+00 | 7.24E+00 | 1.02E+01 | 4.53E+00 | −1.59E−01 |
| H | 1.29E+01 | 0.00E+00 | 0.00E+00 | −8.76E−01 | −6.78E−16 | −2.18E+00 | −3.87E+00 | 1.02E+00 | 2.77E−02 |
| I | −8.57E−17 | 0.00E+00 | 0.00E+00 | −5.03E−18 | −7.32E−17 | 2.81E−01 | 6.66E−01 | 8.58E−02 | −2.12E−03 |

In addition, in the optical system 1000 according to the second embodiment, the first distance d12 between the sensor-side surface of the first lens 110 and the object-side surface of the second lens 120 in a direction perpendicular to the optical axis with respect to the optical axis may be as shown in Table 8 below.

TABLE 8

| Vertical height (mm) of the | | Vertical height (mm) of the |
|---|---|---|
| optical axis from the optical | | optical axis from the optical |
| axis at the sensor-side surface | | axis at the object-side surface |
| of the first lens | First distance (d12) (mm) | of the second lens |
| 0 | 0.8634 | 0 |
| 0.1 | 0.8615 | 0.1 |
| 0.2 | 0.8555 | 0.2 |
| 0.3 | 0.8446 | 0.3 |
| 0.4 | 0.8275 | 0.4 |
| 0.5 | 0.8021 | 0.5 |
| 0.6 | 0.7650 | 0.6 |
| 0.7 | 0.7108 | 0.7 |
| 0.8 | 0.6316 | 0.8 |
| 0.9 | 0.5182 | 0.9 |
| 0.982(EG1) | 0.3678 | 0.982 (EG1) |

Referring to Table 8, the first distance may be reduced from the optical axis OA to the first point EG1 located on the third surface S3. The first point EG1 may be the end of the effective diameter of the second lens 120. Here, the value of the first point EG1 may mean an effective radius value of the third surface S3 having a smaller effective diameter of the sensor-side surface (second surface S2) of the first lens 110 and the object-side surface (third surface S3) of the second lens 120 facing each other, and means an effective radius value of the third surface S3 shown in Table 8. The first distance may have a maximum value at the optical axis OA and a minimum value at the first point EG1. The maximum value of the first distance may be about 2 to about 3 times the minimum value. For example, in the second embodiment, the maximum value of the first distance may be about 2.34 times the minimum value. In the optical system 1000 according to the second embodiment, the first lens 110 and the second lens 120 may have the first distance along a region, so that the optical system 1000 may effectively control the light incident through the first lens 110 at a large viewing angle. In addition, in the optical system 1000 according to the second embodiment, a second distance d78 between the sensor-side surface of the seventh lens 170 and the object-side surface of the eighth lens 180 in a direction perpendicular to the optical axis with respect to the optical axis may be as shown in Table 11 below.

TABLE 9

| Vertical height (mm) of the | | Vertical height (mm) of the |
|---|---|---|
| optical axis from the optical | | optical axis from the optical |
| axis at the sensor-side surface | | axis on the object-side surface |
| of the seventh lens | Second distance (d78) (mm) | of the eighth lens |
| 0.000 | 0.1221 | 0.000 |
| 0.100 | 0.1197 | 0.100 |
| 0.200 | 0.1133 | 0.200 |
| 0.300 | 0.1050 | 0.300 |
| 0.400 | 0.0969 | 0.400 |
| 0.500 | 0.0903 | 0.500 |
| 0.600 | 0.0853 | 0.600 |
| 0.700 | 0.0805 | 0.700 |
| 0.800(EG2) | 0.0764 | 0.800 (EG2) |
| 0.900 | 0.0778 | 0.900 |
| 1.000 (P3) | 0.0891 | 1.000 (P3) |
| 1.056 (EG4) | 0.0528 | 1.056 (EG4) |

Referring to Table 9, the second distance may decrease from the optical axis OA toward the second point EG2 located on the fourteenth surface S14. The second point EG2 may be disposed in a range of about 60% to about 85% of an effective radius of the fourteenth surface S14 with respect to the optical axis OA. For example, in the second embodiment, the second point EG2 may be disposed at a position that is about 75.7% of the effective radius of the fourteenth surface S14 with respect to the optical axis OA. The second distance may increase from the second point EG2 to the third point EG3 positioned on the fourteenth surface S14. The third point EG3 may be disposed in a range of about 90% to about 98% of an effective radius of the fourteenth surface S14 with respect to the optical axis OA. For example, in the second embodiment, the third point EG3 may be disposed at a position of about 94.6%. The second distance may decrease from the third point EG3 to the fourth point EG4 that is the end of the effective diameter of the fourteenth surface S14. Here, the value of the fourth point EG4 is an effective radius value of the fourteenth surface S14 having a smaller effective diameter among the sensor-side surface (fourteenth surface S14) of the seventh lens 170 and the object-side surface (fifteenth surface S15) of the eighth lens 180 facing each other, and means an effective radius value of the fourteenth surface S14 described in Table 8. The second distance may have a maximum value at the optical axis OA and a minimum value at the fourth point EG4. The maximum value of the second distance may be about 2 times to about 3 times the minimum value. For example, in the second embodiment, the maximum value of the second distance may be about 2.31 times the minimum value. Accordingly, the optical system 1000 may have improved optical characteristics not only in the central portion of the field of view (FOV) but also in the peripheral portion. In detail, the optical system 1000 according to the embodiment may have improved distortion control characteristics as the seventh lens 170 and the eighth lens 180 are spaced apart at distances set according to positions.

Also, in the optical system 1000 according to the second embodiment, a third distance d89 between the sensor-side surface of the eighth lens 180 and the object-side surface of the ninth lens 190 in a direction perpendicular to the optical axis with respect to the optical axis may be as shown in Table 10 below.

TABLE 10

| Vertical height (mm) of the | | Vertical height (mm) of the |
|---|---|---|
| optical axis from the optical | | optical axis from the optical |
| axis at the sensor side of the | | axis on the object side of the |
| eighth lens | Third distance (d89) (mm) | ninth lens |
| 0.000 | 0.0300 | 0.000 |
| 0.100 | 0.0388 | 0.100 |
| 0.200 | 0.0638 | 0.200 |
| 0.300 | 0.1010 | 0.300 |
| 0.400 | 0.1450 | 0.400 |
| 0.500 | 0.1898 | 0.500 |
| 0.600 | 0.2306 | 0.600 |
| 0.700 | 0.2635 | 0.700 |
| 0.800(EG5) | 0.2831 | 0.800 (EG5) |
| 0.900 | 0.2800 | 0.900 |
| 1.000 | 0.2399 | 1.000 |
| 1.14(EG6) | 0.1599 | 1.14EG6) |

Referring to Table 10, the third distance may increase from the optical axis OA toward a fifth point EG5 located on the sixteenth surface S16. The fifth point EG5 may be disposed in a range of about 60% to about 80% of an effective radius of the sixteenth surface S16 based on the optical axis OA. For example, in the second embodiment, the fifth point EG5 may be disposed at a position that is about 69.9% of the effective radius of the sixteenth surface S16 with respect to the optical axis OA. Also, the third distance may decrease from the fifth point EG5 to the sixth point EG6 that is the outer end of the effective diameter of the sixteenth surface S16. Here, the value of the sixth point EG6 is an effective radius value of the sixteenth surface S16 having a smaller effective diameter of the sensor-side surface (sixteenth surface S16) of the eighth lens 180 and the object-side surface (seventeenth surface S17) of the ninth lens 190 facing each other, and means an effective radius value of the sixteenth surface S16 described in Table 8. The third distance may have a maximum value at the fifth point EG5 and a minimum value at the optical axis OA. The maximum value of the third distance may be about 5 times to about 15 times the minimum value. For example, in the second embodiment, the maximum value of the second distance may be about 9.43 times the minimum value. Accordingly, the optical system 1000 may have improved optical characteristics not only in the central portion of the field of view (FOV) but also in the peripheral portion. In detail, the optical system 1000 according to the embodiment may have improved distortion control characteristics as the eighth lens 180 and the ninth lens 190 are spaced apart at distances set according to positions. The optical system 1000 according to the second embodiment may have good optical performance at the center portion and the periphery portion of the field of view (FOV), and may have aberration characteristics as shown in FIG. 4.

The optical system 1000 according to the second embodiment has improved resolution and may effectively control light incident at a large viewing angle. In addition, the optical system 1000 may have a smaller TTL and may be provided in a slim and compact structure. In addition, the optical system 1000 may have good optical performance at the center portion and the periphery portion of the field of view (FOV), and may have aberration characteristics as shown in FIG. 4.

FIG. 4 is a graph of the aberration characteristics of the optical system 1000 according to the second embodiment, in which spherical aberration (Longitudinal spherical aberration), astigmatic field curves, and distortion are measured from left to right. In FIG. 4, the X-axis may indicate a focal length (mm) or distortion (%), and the Y-axis may indicate the height of an image. In addition, the graph for spherical aberration is a graph for light in a wavelength band of about 436 nm, about 486 nm, about 546 nm, about 587 nm (d-line), and about 656 nm, and the graph for astigmatism and distortion aberration is a graph for light in the wavelength band of 587 nm. That is, referring to FIG. 4, the optical system 1000 according to the second embodiment may have excellent aberration and distortion characteristics in an improved wide angle of view as the plurality of lenses 100 have a set shape and focal length. In addition, the optical system 1000 may provide good optical performance not only at the center portion of the field of view (FOV) but also at the periphery portion.

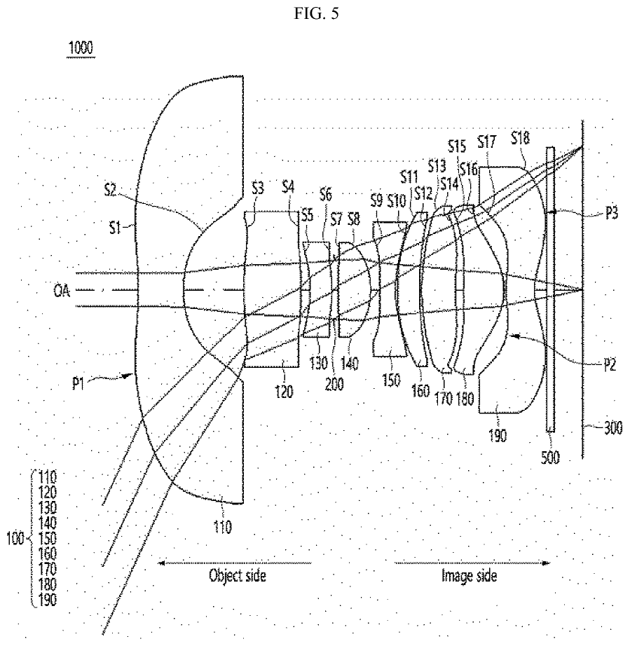

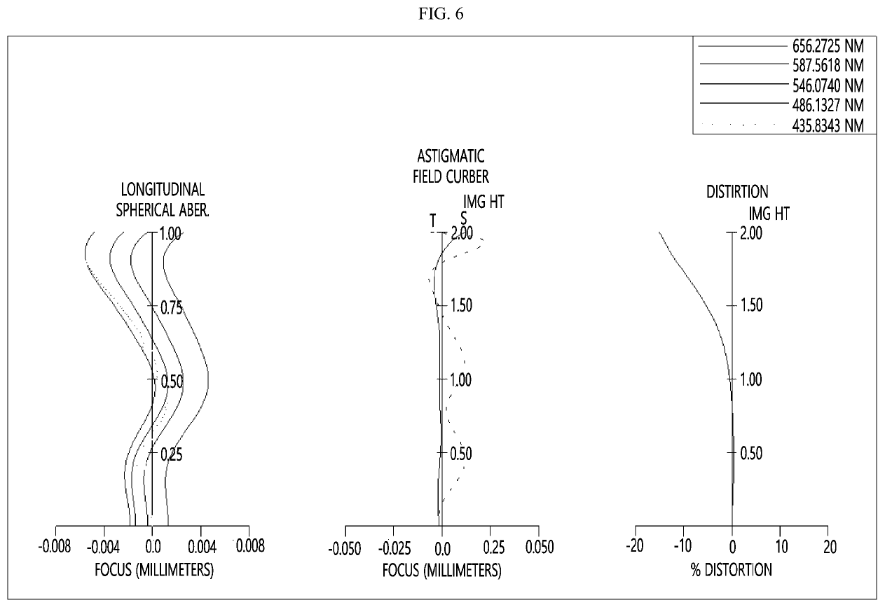

FIG. 5 is a configuration diagram of an optical system according to the third embodiment, and FIG. 6 is a graph illustrating aberration characteristics of the optical system according to the third embodiment.

Referring to FIGS. 5 and 6, the optical system 1000 according to the third embodiment may include the first lens 110, the second lens 120, the third lens 130 the fourth lens 140, the fifth lens 150, the sixth lens 160, the seventh lens 170, the eighth lens 180, the ninth lens 190 and the image sensor 300 sequentially arranged from the object side to the sensor side. The first to ninth lenses 110, 120, 130, 140, 150, 160, 170, 180 and 190 may be sequentially disposed along the optical axis OA of the optical system 1000. In the optical system 1000 according to the third embodiment, an aperture stop may be disposed between the third lens 130 and the fourth lens 140. A filter 500 may be disposed between the plurality of lenses 100 and the image sensor 300. In detail, the filter 500 may be disposed between the ninth lens 190 and the image sensor 300.

TABLE 11

| | | | | | | | Effective |
|---|---|---|---|---|---|---|---|
| | | Radius of | Thickness(mm)/ | Reflective | Abbe | Effective | diameter |
| Lens | Surface | curvature | Distance(mm) | Index | number | radius(mm) | (mm) |
| Lens 1 | S1 | −4.343 | 0.638 | 1.5312 | | 2.700 | 5.40 |
| | S2 | 1.508 | 0.857 | | 56.5100 | 1.226 | 2.45 |
| Lens 2 | S3 | 3.966 | 0.808 | 1.6142 | 25.5900 | 0.986 | 1.97 |
| | S4 | −7.420 | 0.132 | | | 0.672 | 1.34 |
| Lens 3 | S5 | −1.664 | 0.310 | 1.5312 | 56.5100 | 0.604 | 1.21 |
| | S6 | −1.840 | 0.030 | | | 0.465 | 0.93 |
| Stop | | Infinity | 0.057 | | | 0.407 | 0.81 |
| Lens 4 | S7 | 6.904 | 0.461 | 1.5312 | 56.5100 | 0.477 | 0.95 |
| | S8 | −1.001 | 0.128 | | | 0.601 | 1.20 |
| Lens 5 | S9 | −466.904 | 0.220 | 1.6510 | 21.4800 | 0.684 | 1.37 |
| | S10 | 1.396 | 0.030 | | | 0.851 | 1.70 |
| Lens 6 | S11 | 2.471 | 0.314 | 1.5312 | 56.5100 | 0.926 | 1.85 |
| | S12 | 4.379 | 0.030 | | | 0.974 | 1.95 |
| Lens 7 | S13 | 2.134 | 0.477 | 1.5312 | 56.5100 | 1.017 | 2.03 |
| | S14 | 2.960 | 0.124 | | | 1.055 | 2.11 |
| Lens 8 | S15 | −5.759 | 0.565 | 1.5312 | 56.5100 | 1.075 | 2.15 |
| | S16 | −0.785 | 0.030 | | | 1.14 | 2.28 |
| Lens 9 | S17 | 1.831 | 0.400 | 1.6142 | 25.5900 | 1.18 | 2.36 |
| | S18 | 0.791 | 0.173 | | | 1.630 | 3.26 |
| Filter | | Infinity | 0.110 | | | 1.762 | 3.52 |
| | | Infinity | 0.399 | | | 1.796 | 3.59 |
| Image | | Infinity | 0.001 | | | 2.000 | 4.00 |
| sensor | | | | | | | |

Table 11 shows, in the first to ninth lenses 110, 120, 130, 140, 150, 160, 170, 180, and 190 according to the third embodiment, the radius of curvature on the optical axis, the center thickness of each lens, and the center distance between adjacent lenses, refractive index at d-line, Abbe number and the effective diameter (clear aperture (CA)). Referring to FIG. 5 and Table 11, in the optical system 1000 according to the third embodiment, the first lens 110 may have a negative refractive power on the optical axis OA. The first surface S1 of the first lens 110 may have a concave shape on the optical axis OA, and the second surface S2 may have a concave shape on the optical axis OA. The first lens 110 may have a concave shape on both sides of the optical axis OA. The first surface S1 may be an aspherical surface, and the second surface S2 may be an aspherical surface. The first surface S1 and the second surface S2 may have aspheric coefficients as shown in Table 12 below. The first lens 110 may have the largest effective diameter (CA) among the plurality of lenses 100. In detail, the first surface S1 of the first lens 110 may have the largest effective diameter (CA) among the first to eighteenth surfaces S1 to S18. The first lens 110 may include a critical point. In detail, the above-described first critical point P1 may be disposed on the first surface S1 of the first lens 110.

The second lens 120 may have a positive (+) refractive power on the optical axis OA. The third surface S3 of the second lens 120 may have a convex shape on the optical axis OA, and the fourth surface S4 may have a convex shape on the optical axis OA. The second lens 120 may have a shape in which both sides are convex on the optical axis OA. The third surface S3 may be an aspherical surface, and the fourth surface S4 may be an aspherical surface. The third surface S3 and the fourth surface S4 may have aspheric coefficients as shown in Table 12 below.

The third lens 130 may have negative (−) refractive power on the optical axis OA. The fifth surface S5 of the third lens 130 may have a concave shape on the optical axis OA, and the sixth surface S6 may be convex on the optical axis OA. The third lens 130 may have a meniscus shape convex from the optical axis OA toward the sensor side. The fifth surface S5 may be an aspherical surface, and the sixth surface S6 may be an aspherical surface. The fifth surface S5 and the sixth surface S6 may have aspheric coefficients as shown in Table 12 below.

The fourth lens 140 may have positive (+) refractive power on the optical axis OA. The seventh surface S7 of the fourth lens 140 may have a convex shape on the optical axis OA, and the eighth surface S8 may have a convex shape on the optical axis OA. The fourth lens 140 may have a shape in which both sides are convex on the optical axis OA. The seventh surface S7 may be an aspherical surface, and the eighth surface S8 may be an aspherical surface. The seventh surface S7 and the eighth surface S8 may have aspheric coefficients as shown in Table 12 below.

The fifth lens 150 may have negative (−) refractive power on the optical axis OA. The ninth surface S9 of the fifth lens 150 may have a concave shape on the optical axis OA, and the tenth surface S10 may have a concave shape on the optical axis OA. The fifth lens 150 may have a concave shape on both sides of the optical axis OA. The ninth surface S9 may be an aspherical surface, and the tenth surface S10 may be an aspherical surface. The ninth surface S9 and the tenth surface S10 may have aspheric coefficients as shown in Table 12 below.

The sixth lens 160 may have a positive (+) refractive power on the optical axis OA. The eleventh surface S11 of the sixth lens 160 may have a convex shape along the optical axis OA, and the twelfth surface S12 may have a concave shape on the optical axis OA. The sixth lens 160 may have a meniscus shape convex from the optical axis OA toward the object side. The eleventh surface S11 may be an aspherical surface, and the twelfth surface S12 may be an aspherical surface. The eleventh surface S11 and the twelfth surface S12 may have aspheric coefficients as shown in Table 12 below.

The seventh lens 170 may have a positive (+) refractive power on the optical axis OA. The thirteenth surface S13 of the seventh lens 170 may have a convex shape on the optical axis OA, and the fourteenth surface S14 may have a concave shape on the optical axis OA. The seventh lens 170 may have a meniscus shape convex from the optical axis OA toward the object side. The thirteenth surface S13 may be an aspherical surface, and the fourteenth surface S14 may be an aspherical surface. The thirteenth surface S13 and the fourteenth surface S14 may have aspheric coefficients as shown in Table 12 below.

The eighth lens 180 may have positive (+) refractive power on the optical axis OA. The fifteenth surface S15 of the eighth lens 180 may have a concave shape on the optical axis OA, and the sixteenth surface S16 may have a convex shape on the optical axis OA. The eighth lens 180 may have a meniscus shape convex from the optical axis OA toward the sensor side. The fifteenth surface S15 may be an aspherical surface, and the sixteenth surface S16 may be an aspherical surface. The fifteenth surface S15 and the sixteenth surface S16 may have aspheric coefficients as shown in Table 12 below.

The ninth lens 190 may have a negative refractive power on the optical axis OA. The seventeenth surface S17 of the ninth lens 190 may have a convex shape on the optical axis OA, and the eighteenth surface S18 may have a concave shape on the optical axis OA. The ninth lens 190 may have a meniscus shape convex from the optical axis OA toward the object side. The seventeenth surface S17 may be an aspherical surface, and the eighteenth surface S18 may be an aspherical surface. The seventeenth surface S17 and the eighteenth surface S18 may have aspherical coefficients as shown in Table 12 below. The ninth lens 190 may include a critical point. In detail, the above-described second critical point P2 may be disposed on the seventeenth surface S17 of the ninth lens 190. In addition, the above-described third critical point P3 may be disposed on the eighteenth surface S18 of the ninth lens 190.

Table 12 below shows the values of the aspheric coefficients of each lens surface in the optical system 1000 according to the third embodiment.

TABLE 12

| | L1 | | L2 | | L3 | | L4 | | L5 |
|---|---|---|---|---|---|---|---|---|---|
| | S1 | S2 | S3 | S4 | S5 | S6 | S7 | S8 | S9 |
| K | 7.19E−01 | −2.01E−01 | 1.01E+01 | 8.96E+01 | −9.64E−01 | −9.14E+00 | 6.11E+01 | 8.55E−01 | 9.50E+01 |
| A | 1.16E−01 | 9.83E−02 | −8.43E−02 | 2.72E−02 | 7.17E−02 | 8.10E−02 | 6.63E−02 | 3.49E−01 | −1.37E−01 |
| B | −5.71E−02 | 2.12E−01 | 1.59E−01 | −1.64E−01 | 5.17E−02 | 4.51E−01 | −3.74E+00 | 2.66E+00 | −1.39E+00 |
| C | 2.45E−02 | −6.19E−01 | −9.62E−01 | 7.14E−01 | 6.63E−02 | −7.31E−01 | 8.29E+01 | 1.79E+01 | 4.00E+00 |
| D | −8.05E−03 | 1.32E+00 | 2.58E+00 | −6.77E+00 | 1.03E+00 | 4.64E+00 | −1.24E+03 | −1.15E+02 | −4.21E+00 |
| E | 1.90E−03 | −1.77E+00 | −4.66E+00 | 3.47E+01 | 2.16E−11 | 2.19E−11 | 1.15E+04 | 6.03E+02 | −1.59E+01 |
| F | −3.09E−04 | 1.48E+00 | 4.85E+00 | −9.36E+01 | 6.32E−12 | 6.34E−12 | −6.78E+04 | −2.25E+03 | 9.44E+01 |
| G | 3.28E−05 | −7.06E−01 | −2.60E+00 | 1.53E+02 | 1.83E−12 | 1.83E−12 | 2.44E+05 | 5.31E+03 | −2.34E+02 |
| H | −2.03E−06 | 1.42E−01 | 5.62E−01 | 1.39E+02 | 5.28E−13 | 5.28E−13 | −4.94E+05 | 6.98E+03 | 2.96E+02 |
| I | 5.60E−08 | 2.15E−20 | −6.34E−17 | 5.63E+01 | 1.52E−13 | 1.52E−13 | 4.29E+05 | 3.83E+03 | −1.56E+02 |
| | L5 | L6 | | L7 | | L8 | | L9 | |
| | S10 | S11 | S12 | S13 | S14 | S15 | S16 | S17 | S18 |
| K | 6.18E−02 | 7.96E−01 | −2.31E+01 | −3.99E+01 | −9.01E+01 | 1.74E+01 | −8.16E−01 | −2.23E−01 | 3.67E+00 |
| A | −4.79E−01 | 4.42E−03 | −1.21E−02 | −7.16E−02 | 3.96E−02 | 5.06E−01 | 4.84E−01 | −8.09E−01 | −7.52E−01 |
| B | 1.25E+00 | 8.71E−03 | 3.19E−02 | 6.49E−02 | −1.27E+00 | −2.04E+00 | −1.29E+00 | −4.16E−01 | 1.39E+00 |
| C | −5.68E+00 | 3.21E−02 | 1.87E−02 | 1.38E+00 | 2.63E+00 | 3.84E+00 | 4.70E+00 | 4.61E+00 | 1.86E+00 |
| D | 1.95E+01 | −2.95E−02 | −1.75E−02 | −4.86E+00 | −3.16E+00 | −6.74E+00 | −1.13E+01 | −1.10E+01 | 1.75E+00 |
| E | 4.26E+01 | 2.64E−13 | −3.28E−13 | 8.27E+00 | 3.50E+00 | 1.13E+01 | 1.70E+01 | 1.40E+01 | −1.17E+00 |
| F | 5.63E+01 | 3.70E−15 | −1.32E−14 | −8.07E+00 | −2.94E+00 | −1.22E+01 | −1.64E+01 | 1.05E+01 | 5.34E−01 |
| G | −4.14E+01 | −2.16E−15 | −4.48E−15 | 4.19E+00 | 1.03E+00 | 7.24E+00 | 1.02E+01 | 4.53E+00 | −1.59E−01 |
| H | 1.29E+01 | 0.00E+00 | 0.00E+00 | −8.76E−01 | −6.47E−16 | −2.18E+00 | −3.87E+00 | −1.02E+00 | 2.77E−02 |
| I | −8.19E−17 | 0.00E+00 | 0.00E+00 | −1.10E−18 | −6.94E−17 | 2.81E−01 | 6.66E−01 | 8.58E−02 | −2.12E−03 |

In addition, in the optical system 1000 according to the third embodiment, the first distance D12 between the sensor-side surface of the first lens 110 and the object-side surface of the second lens 120 that is drawn in a direction perpendicular to the optical axis with respect to the optical axis may be as shown in Table 13 below.

TABLE 13

| Vertical height (mm) of the | | Vertical height (mm) of the |
|---|---|---|
| optical axis from the optical | | optical axis from the optical |
| axis at the sensor-side surface | | axis at the object-side surface |
| of the first lens | First distance (d12) (mm) | of the second lens |
| 0 | 0.8569 | 0 |
| 0.1 | 0.8548 | 0.1 |
| 0.2 | 0.8484 | 0.2 |
| 0.3 | 0.8368 | 0.3 |
| 0.4 | 0.8189 | 0.4 |
| 0.5 | 0.7923 | 0.5 |
| 0.6 | 0.7538 | 0.6 |
| 0.7 | 0.6982 | 0.7 |
| 0.8 | 0.6175 | 0.8 |
| 0.9 | 0.5029 | 0.9 |
| 0.986(EG1) | 0.3524 | 0.986(EG1) |

Referring to Table 13, the first distance may be reduced from the optical axis OA to the first point EG1 located on the third surface S3. The first point EG1 may be the outer end of the effective diameter of the third lens 130. Here, the value of the first point EG1 may mean an effective radius value of the third surface S3 having a smaller effective diameter of the sensor-side surface (second surface S2) of the first lens 110 and the object-side surface (third surface S3) of the second lens 120 facing each other, and means an effective radius value of the third surface S3 shown in Table 15. The first distance may have a maximum value at the optical axis OA and a minimum value at the first point EG1. The maximum value of the first distance may be about 2 times to about 3 times the minimum value. For example, in the third embodiment, the maximum value of the first distance may be about 2.34 times the minimum value. In the optical system 1000 according to the third embodiment, the first lens 110 and the second lens 120 may have the first distance according to an area. Accordingly, the optical system 1000 may effectively control the light incident through the first lens 110 at a large viewing angle.

In the optical system 1000 according to the third embodiment, the second distance between the sensor-side surface of the seventh lens 170 and the object-side surface of the eighth lens 180 in a direction perpendicular to the optical axis with respect to the optical axis may be as shown in Table 14 below.

TABLE 14

| Vertical height (mm) of the | | Vertical height (mm) of the |
|---|---|---|
| optical axis from the optical | | optical axis from the optical |
| axis at the sensor-side surface | | axis on the object-side surface |
| of the seventh lens | Second distance (d78) (mm) | of the eighth lens |
| 0.000 | 0.1239 | 0.000 |
| 0.100 | 0.1214 | 0.100 |
| 0.200 | 0.1149 | 0.200 |
| 0.300 | 0.1065 | 0.300 |
| 0.400 | 0.0984 | 0.400 |
| 0.500 | 0.0919 | 0.500 |
| 0.600 | 0.0868 | 0.600 |
| 0.700(EG2) | 0.0821 | 0.700 (EG2) |
| 0.800 | 0.0780 | 0.800 |
| 0.900 | 0.0790 | 0.900 |
| 1.000(EG3) | 0.0892 | 1.000 (EG3) |
| 1.14(EG4) | 0.0502 | 1.14(EG4) |

Referring to Table 14, the second distance may decrease from the optical axis OA toward the second point EG2 located on the fourteenth surface S14. The second point EG2 may be disposed in a range of about 60% to about 85% of an effective radius of the fourteenth surface S14 with respect to the optical axis OA. For example, in the third embodiment, the second point EG2 may be disposed at a position that is about 75.8% of the effective radius of the fourteenth surface S14 with respect to the optical axis OA. The second distance may increase from the second point EG2 to the third point EG3 positioned on the fourteenth surface S14. The third point EG3 may be disposed in a range of about 90% to about 98% of an effective radius of the fourteenth surface S14 with respect to the optical axis OA. For example, in the third embodiment, the third point EG3 may be disposed at a position that is about 94.8% of the effective radius of the fourteenth surface S14 with respect to the optical axis OA. The second distance may decrease from the third point EG3 to the fourth point EG4 that is the end of the effective diameter of the fourteenth surface S14. Here, the value of the fourth point EG4 is an effective radius value of the fourteenth surface S14 having a smaller effective diameter among the sensor-side surface (fourteenth surface S14) of the seventh lens 170 and the object-side surface (fifteenth surface S15) of the eighth lens 180 facing each other, and means an effective radius value of the fourteenth surface S14 described in Table 15. The second distance may have a maximum value at the optical axis OA and a minimum value at the fourth point EG4. The maximum value of the second distance may be about 2 times to about 3 times the minimum value. For example, in the third embodiment, the maximum value of the second distance may be about 2.43 times the minimum value. Accordingly, the optical system 1000 may have improved optical characteristics not only in the central portion of the field of view (FOV) but also in the peripheral portion. In detail, the optical system 1000 according to the embodiment may have improved distortion control characteristics as the seventh lens 170 and the eighth lens 180 are spaced apart at distances set according to positions.

In the optical system 1000 according to the third embodiment, a third distance d89 between the sensor-side surface of the eighth lens 180 and the object-side surface of the ninth lens 190 in a direction perpendicular to the optical axis with respect to the optical axis may be as shown in Table 15 below.

TABLE 15

| Vertical height (mm) of the | | Vertical height (mm) of the |
|---|---|---|
| optical axis from the optical | | optical axis from the optical |
| axis at the sensor side of the | | axis on the object side of the |
| eighth lens | Third distance (d89) (mm) | ninth lens |
| 0.000 | 0.0300 | 0.000 |
| 0.100 | 0.0390 | 0.100 |
| 0.200 | 0.0645 | 0.200 |
| 0.300 | 0.1026 | 0.300 |
| 0.400 | 0.1477 | 0.400 |
| 0.500 | 0.1939 | 0.500 |
| 0.600 | 0.2363 | 0.600 |
| 0.700 | 0.2705 | 0.700 |
| 0.800 (EG5) | 0.2911 | 0.800 (EG5) |
| 0.900 | 0.2879 | 0.900 |
| 1.000 | 0.2464 | 1.000 |
| 1.14(EG6) | 0.1628 | 1.14EG6) |

Referring to Table 15, the third distance may increase from the optical axis OA toward a fifth point EG5 located on the sixteenth surface S16. The fifth point EG5 may be disposed in a range of about 60% to about 80% of an effective radius of the sixteenth surface S16 based on the optical axis OA. For example, in the third embodiment, the fifth point EG5 may be disposed at a position that is about 70.19% of the effective radius of the sixteenth surface S16 with respect to the optical axis OA. Also, the third distance may decrease from the fifth point EG5 to the sixth point EG6 that is the outer end of the effective diameter of the sixteenth surface S16. Here, the value of the sixth point EG6 is an effective radius value of the sixteenth surface S16 having a smaller effective diameter of the sensor-side surface (sixteenth surface S16) of the eighth lens 180 and the object-side surface (seventeenth surface S17) of the ninth lens 190 facing each other, and means an effective radius value of the sixteenth surface S16 described in Table 11. The third distance may have a maximum value at the fifth point EG5 and a minimum value at the optical axis OA. The maximum value of the third distance may be about 5 times to about 15 times the minimum value. For example, in the third embodiment, the maximum value of the second distance may be about 9.7 times the minimum value. Accordingly, the optical system 1000 may have improved optical characteristics not only in the central portion of the field of view (FOV) but also in the peripheral portion. In detail, the optical system 1000 according to the embodiment may have improved distortion control characteristics as the eighth lens 180 and the ninth lens 190 are spaced apart at distances set according to positions.

The optical system 1000 according to the third embodiment has improved resolution and may effectively control light incident at a large viewing angle. In addition, the optical system 1000 may have a smaller TTL and may be provided in a slim and compact structure. In addition, the optical system 1000 may have good optical performance at the center portion and the periphery portion of the field of view (FOV), and may have good aberration characteristics as shown in FIG. 6.

FIG. 6 is a graph of the aberration characteristics of the optical system 1000 according to the third embodiment, in which spherical aberration (Longitudinal spherical aberration), astigmatic field curves, and distortion are measured from left to right. In FIG. 6, the X-axis may indicate a focal length (mm) or distortion (%), and the Y-axis may indicate the height of an image. In addition, the graph for spherical aberration is a graph for light in a wavelength band of about 436 nm, about 486 nm, about 546 nm, about 587 nm (d-line), and about 656 nm, and the graph for astigmatism and distortion aberration is a graph for light in the wavelength band of 587 nm. That is, referring to FIG. 6, the optical system 1000 according to the third embodiment may have excellent aberration and distortion characteristics in an improved wide angle of view as the plurality of lenses 100 have a set shape and focal length. In addition, the optical system 1000 may provide good optical performance not only at the center portion of the field of view (FOV) but also at the periphery portion.

TABLE 16

| | | | |
|---|---|---|---|
| Item | First embodiment | Second embodiment | Third embodiment |

| F | 1.1961 | mm | 1.1444 | mm | 1.0967 | mm |
|---|---|---|---|---|---|---|
| f1 | −2.1344 | mm | −2.0665 | mm | −2.0220 | mm |
| f2 | 4.1704 | mm | 4.2339 | mm | 4.2854 | mm |
| f3 | −151.4479 | mm | −84.4074 | mm | −83.8454 | mm |
| f4 | 1.6887 | mm | 1.6761 | mm | 1.6728 | mm |
| f5 | −2.3071 | mm | −2.1653 | mm | −2.1142 | mm |
| f6 | 11.6048 | mm | 10.5626 | mm | 10.0580 | mm |
| f7 | 15.3333 | mm | 12.4246 | mm | 11.9352 | mm |
| f8 | 1.7183 | mm | 1.6862 | mm | 1.6391 | mm |
| f9 | −2.2892 | mm | −2.4618 | mm | −2.6325 | mm |
| L1_ET | 1.0163 | mm | 0.9930 | mm | 0.9299 | mm |
| L2_ET | 0.7761 | mm | 0.7553 | mm | 0.7566 | mm |
| L3_ET | 0.2680 | mm | 0.3178 | mm | 0.3562 | mm |
| L4_ET | 0.2353 | mm | 0.2265 | mm | 0.2247 | mm |
| L5_ET | 0.4346 | mm | 0.4490 | mm | 0.4474 | mm |
| L6_ET | 0.2180 | mm | 0.2199 | mm | 0.2219 | mm |
| L7_ET | 0.2180 | mm | 0.2199 | mm | 0.2220 | mm |
| L8_ET | 0.2809 | mm | 0.2800 | mm | 0.2790 | mm |
| L9_ET | 0.7120 | mm | 0.7032 | mm | 0.6905 | mm |
| CA_max | 5.4 | mm | 5.4 | mm | 5.4 | mm |
| CA_min | 0.98 | mm | 0.96 | mm | 0.93 | mm |
| CA_aver | 1.99 | mm | 2.00 | mm | 1.99 | mm |
| TD1 | 2.838 | mm | 2.792 | mm | 2.744 | mm |
| TD2 | 2.164 | mm | 2.186 | mm | 2.191 | mm |
| TTL | 6.3869 | mm | 6.3583 | mm | 6.2932 | mm |
| BFL | 0.72 | mm | 0.6937 | mm | 0.6826 | mm |
| ImgH | 4.0 | mm | 4.0 | mm | 4.0 | mm |
| EPD | 0.4984 | | 0.4768 | | 0.4570 | |
| F-number | 2.4 | | 2.4 | | 2.4 | |
| FOV | 120 | degrees | 125 | degrees | 130 | degrees |

Table 16 shows the items of the above-described equations in the optical system 1000 according to the first, second, and third embodiments, and the total track length (TTL), back focal length (BFL), and F value of the optical system 1000, ImgH, field of view, the focal lengths f1, f2, f3, f4, f5, f6, f7, f8, and f9 of each of the first to ninth lenses 110, 120, 130, 140, 150, 160, 170, 180, and 190, edge thickness (ET), etc. will be. Here, the edge thickness of each lens means the thickness in a direction of the optical axis OA at the end of the effective region of each lens. In detail, the edge thickness of each lens means the distance in the direction of the optical axis OA from the end of the effective region on the object side of each lens to the end of the effective region on the sensor side.

TABLE 17

| | | First | Second | Third |
|---|---|---|---|---|
| Equation | | embodiment | embodiment | embodiment |
| 1 | 1 < f4/F < 2 | 1.412 | 1.465 | 1.525 |
| 2 | 1.4 < nd1 < 1.6 | 1.531 | 1.531 | 1.531 |
| 3 | 10 < Vd5 < 30 | 21.480 | 21.480 | 21.480 |
| 4 | 1 < F/EPD < 3 | 2.400 | 2.400 | 2.400 |
| 5 | 1 < L1 CT/L5 CT < 5 | 3.602 | 3.209 | 2.898 |
| 6 | 1 < L8 CT/L5 CT < 5 | 2.620 | 2.566 | 2.570 |
| 7 | 0.5 < \|f5\| / \|f4\| < 3 | 1.366 | 1.292 | 1.264 |
| 8 | 1 < CA_L1S1/CA_L3S1 < 8 | 4.499 | 4.472 | 4.468 |
| 9 | 1 < CA_L9S2/CA_L4S2 < 8 | 2.631 | 2.657 | 2.714 |
| 10 | 0.5 < d12_CT/L1 CT < 2 | 1.060 | 1.223 | 1.344 |
| 11 | 1.5 < CA_L1S1/CA_L1S2 < 3 | 2.223 | 2.210 | 2.203 |
| 12 | 2 < d12_CT/d12_ET < 3 | 2.325 | 2.348 | 2.432 |
| 13 | 1 < d89_CT/d89_ET < 2.5 | 1.885 | 1.388 | 1.576 |
| 14 | 0.4 < L1_CT/L1_ET < 1 | 0.780 | 0.711 | 0.686 |
| 15 | 1.5 < L8_CT/L8_ET < 3 | 2.052 | 2.015 | 2.026 |
| 16 | 0.2 < L9_CT/L9_ET < 1 | 0.562 | 0.573 | 0.579 |
| 17 | 3 < L2R1/d12_CT < 6 | 4.561 | 4.525 | 4.628 |
| 18 | 10 < L7R1/d78_CT < 30 | 21.912 | 18.272 | 17.221 |
| 19 | 100 < \|L8R1\|/d89_CT < 300 | 196.203 | 184.727 | 191.963 |
| 20 | −10 < L1R1/L1_CT < −2 | −5.269 | −6.083 | −6.811 |
| 21 | 5 < L4R1/L4_CT < 20 | 14.036 | 14.465 | 14.974 |
| 22 | −5 < L4R2/L4_CT < −1 | −2.054 | −2.100 | −2.171 |
| 23 | 500 < \|L5R2\|/L5_CT < 8500 | 1186.250 | 8153.094 | 2122.292 |
| 24 | −5 < L1R1/L1R2 < −1 | −2.502 | −2.739 | −2.879 |
| 25 | 1 < TD1/TD2 < 5 | 1.311 | 1.277 | 1.252 |
| 26 | 1 < CA_max/ImgH < 3 | 1.350 | 1.350 | 1.350 |
| 27 | 2 < CA_max/CA_aver < 4 | 2.715 | 2.701 | 2.708 |
| 28 | 0.4 < CA_min/CA_aver < 1 | 0.495 | 0.489 | 0.479 |
| 29 | 0 < F < 30 | 1.196 | 1.144 | 1.097 |
| 30 | 2 < TTL < 20 | 6.387 | 6.358 | 6.293 |
| 31 | 2 < ImgH | 4.000 | 4.000 | 4.000 |
| 32 | BFL < 2.5 | 0.719 | 0.694 | 0.683 |
| 33 | 110 degrees < FOV | 120.000 | 125.000 | 130.000 |
| 34 | F# < 3 | 2.4000 | 2.4000 | 2.4000 |
| 35 | 0.2 < TTL/ImgH < 2 | 1.597 | 1.590 | 1.573 |
| 36 | BFL/ImgH < 0.5 | 0.180 | 0.173 | 0.171 |
| 37 | 1 < TTL/BFL < 15 | 8.884 | 9.166 | 9.219 |
| 38 | 0.01 < F/TTL < 1 | 0.187 | 0.180 | 0.174 |
| 39 | 0.5 < F/BFL < 3 | 1.664 | 1.650 | 1.607 |
| 40 | F/ImgH < 0.95 | 0.299 | 0.286 | 0.274 |

Table 17 shows the result values of Equations 1 to 40 described above in the optical system 1000 according to the first, second, and third embodiments. Referring to Table 17, it may be seen that the optical system 1000 according to the first, second, and third embodiments satisfies at least one or all of Equations 1 to 40. In detail, it may be seen that the optical system 1000 according to the first, second, and third embodiments satisfies all of Equations 1 to 40 above. Accordingly, the optical system 1000 according to the first, second, and third embodiments may have good optical performance at the center portion and the periphery portion of the field of view FOV, and may have good aberration characteristics.

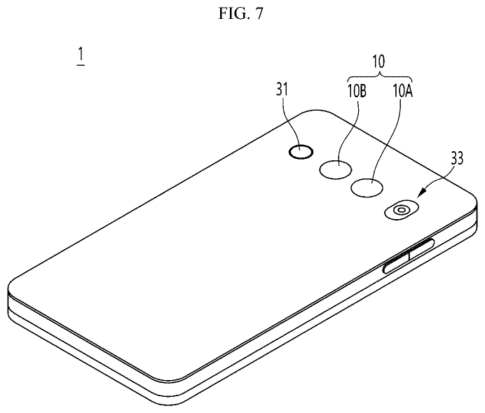

FIG. 7 is a diagram illustrating that the camera module according to the embodiment is applied to a mobile terminal. Referring to FIG. 7, the mobile terminal 1 may include a camera module 10 provided at the rear side. The camera module 10 may include an image capturing function. Also, the camera module 10 may include at least one of an auto focus function, a zoom function, and an OIS function. The camera module 10 may process a still video image or an image frame of a moving image obtained by the image sensor 300 in an imaging mode or a video call mode. The processed image frame may be displayed on a display unit (not shown) of the mobile terminal 1 and may be stored in a memory (not shown). In addition, although not shown in the drawings, the camera module may be further disposed on the front of the mobile terminal 1. For example, the camera module 10 may include a first camera module 10A and a second camera module 10B. In this case, at least one of the first camera module 10A and the second camera module 10B may include the above-described optical system 1000 and the image sensor 300. Accordingly, the camera module 10 may have a slim structure, and may improve distortion and aberration characteristics of a peripheral portion (a region of about 65% or more of an angle of view (FOV)).

The mobile terminal 1 may further include an autofocus device 31. The auto focus device 31 may include an auto focus function using a laser. The auto focus device 31 may be mainly used in a condition in which the auto focus function using the image of the camera module 10 is deteriorated, for example, in proximity of 10 m or less or in a dark environment. The autofocus device 31 may include a light emitting unit including a vertical cavity surface emission laser (VCSEL) semiconductor device and a light receiving unit that converts light energy such as a photodiode into electrical energy. The mobile terminal 1 may further include a flash module 33. The flash module 33 may include a light emitting device emitting light therein. The flash module 33 may be operated by a camera operation of a mobile terminal or a user's control.

Features, structures, effects, etc. described in the above embodiments are included in at least one embodiment of the invention, and are not necessarily limited to only one embodiment. Furthermore, features, structures, effects, etc. illustrated in each embodiment can be combined or modified for other embodiments by those of ordinary skill in the art to which the embodiments belong. Accordingly, the contents related to such combinations and modifications should be interpreted as being included in the scope of the invention. In addition, although the embodiment has been described above, it is only an example and does not limit the invention, and those of ordinary skill in the art to which the invention pertains are exemplified above in a range that does not depart from the essential characteristics of the present embodiment. It can be seen that various modifications and applications that have not been made are possible. For example, each component specifically shown in the embodiment can be implemented by modification. And the differences related to these modifications and applications should be construed as being included in the scope of the invention defined in the appended claims.

1. An optical system comprising:
first to ninth lenses disposed along an optical axis from an object side to a sensor side direction,
wherein the first lens has a negative (−) refractive power on the optical axis,
wherein the fourth lens has a positive (+) refractive power on the optical axis,
wherein the fifth lens has a negative (−) refractive power on the optical axis,
wherein the eighth lens has a positive (+) refractive power on the optical axis,
wherein the ninth lens has a negative (−) refractive power on the optical axis,
wherein an object-side surface of the first lens includes a first critical point, and
wherein the first critical point is disposed in a range of 20% to 50% of an effective radius of the object-side surface of the first lens with respect to the optical axis.

2. The optical system of claim 1,
wherein the object-side surface of the first lens is concave on the optical axis, and a sensor-side surface of the first lens is concave on the optical axis.

3. The optical system of claim 2,
wherein the object-side surface of the first lens has a largest effective diameter among object-side surfaces and sensor-side surfaces of the first to ninth lenses.

4. The optical system of claim 3,
wherein a refractive index for a d-line wavelength of the first lens is nd1,
wherein the following equation satisfies: 1.4<nd1<1.6.

5. The optical system of claim 3,
wherein an Abbe number of the fifth lens is Vd5,
wherein the following equation satisfies: 10<Vd5<30.

6. The optical system of claim 1,
wherein an object-side surface of the ninth lens includes a second critical point, and
wherein the second critical point is disposed in a range of 20% to 50% of an effective radius of the object-side surface of the ninth lens with respect to the optical axis.

7. The optical system of claim 1,
wherein a sensor-side surface of the ninth lens includes a third critical point, and
wherein the third critical point is disposed in a range of 40% to 70% of an effective radius of the sensor-side surface of the ninth lens with respect to the optical axis.

8. An optical system comprising:
first to ninth lenses disposed along an optical axis in a direction from an object side to a sensor side,
wherein the first lens has a negative (−) refractive power on the optical axis,
wherein the fourth lens has a positive (+) refractive power on the optical axis,
wherein the fifth lens has a negative (−) refractive power on the optical axis,
wherein the eighth lens has a positive (+) refractive power on the optical axis,
wherein the ninth lens has a negative (−) refractive power on the optical axis, and
wherein the optical system has a field of view exceeding 110 degrees,
wherein an object-side surface of the first lens has a concave shape on the optical axis,
wherein an object-side surface of the first lens includes a first critical point disposed in a range of 20% to 50% of an effective radius of the object-side surface of the first lens with respect to the optical axis, and
wherein a sensor-side surface of the second lens has a convex shape on the optical axis.

9. The optical system of claim 8,
wherein the object-side surface of the first lens has a largest effective diameter among object-side surfaces and sensor-side surfaces of the first to ninth lenses.

10. The optical system of claim 9, wherein
CA_L1S1 is an effective diameter of the object-side surface of the first lens,
CA_L1S2 is an effective diameter of the sensor-side surface of the first lens, and
wherein the following equation satisfies: 1.5<CA_L1S1/CA_L1S2<3.

11. The optical system of claim 9, wherein
L1_CT is a thickness of the first lens in the optical axis,
L1_CT is a thickness in a direction of the optical axis at an end of an effective region of the first lens,
wherein the following equation satisfies: 0.4<L1_CT/L1_ET<1.

12. An optical system comprising:
first to ninth lenses disposed along an optical axis in a direction from an object side to a sensor side,
wherein the first lens has a negative (−) refractive power on the optical axis,
wherein the fourth lens has a positive (+) refractive power on the optical axis,
wherein the fifth lens has a negative (−) refractive power on the optical axis,
wherein the eighth lens has a positive (+) refractive power on the optical axis,
wherein the ninth lens has a negative (−) refractive power on the optical axis,
wherein a distance in the direction of the optical axis between the first and second lenses decreases from the optical axis in a direction perpendicular to the optical axis,
wherein an object-side surface of the first lens has a concave shape on the optical axis, and
wherein a sensor-side surface of the second lens has a convex shape on the optical axis.

13. The optical system of claim 12, wherein
d12_CT is a distance in the direction of the optical axis between the first and second lenses on the optical axis,
d12_ET is a distance in the direction of the optical axis between the first and second lenses at an end of an effective region of the object-side surface of the second lens, and
wherein the following equation satisfies: 2<d12_CT/d12_ET<3.

14. The optical system of claim 12,
wherein a distance in the direction of the optical axis between the eighth and ninth lenses increases from the optical axis toward a first point on a sensor-side surface of the eighth lens, and decreases from the first point toward an end of the sensor-side surface of the eighth lens.

15. The optical system of claim 14,
wherein the first point is disposed in a range of 60% to 80% of an effective radius of the sensor-side surface of the eighth lens with respect to the optical axis.

16. The optical system of claim 12,
wherein a sensor-side surface of the fifth lens has a concave shape on the optical axis.

17. The optical system of claim 12,
wherein an effective diameter of the object-side surface of the first lens is a largest among effective diameters of object-side and sensor-side surfaces of the first to ninth lenses,
wherein the object-side surface of the first lens includes a first critical point disposed in a range of 20% to 50% of an effective radius of the object-side surface of the first lens with respect to the optical axis.

18. The optical system of claim 12,
wherein a radius of curvature on the optical axis of an object-side surface of the second lens is L2R1,
wherein a distance between a sensor-side surface of the first lens and the object-side surface of the second lens in the optical axis is d12_CT, and
wherein the following equation satisfies: 3<L2R1/d12_CT<6.

19. The optical system of claim 8,
wherein a radius of curvature of an object-side surface of the seventh lens on the optical axis is L7R1,
wherein a distance between a sensor-side surface of the seventh lens and an object-side surface of the eighth lens in the optical axis is d78_CT, and
wherein the following equation satisfies: 10<L7R1/d78_CT<30.

20. The optical system of claim 8,
wherein a radius of curvature of an object-side surface of the eighth lens on the optical axis is L8R1,
wherein a distance between a sensor-side surface of the eighth lens and an object-side surface of the ninth lens on the optical axis is d89_CT, and
wherein the following equation satisfies: 100<|L8R1|/d89_CT<300.
